(19) United States
(12) Patent Application Publication
(10) Pub. No.: US 2026/0288768 A1
(43) Pub. Date: Sep. 24, 2026

(54) SYSTEM

(71) Applicant: SoftBank Group Corp., Tokyo (JP)

(72) Inventor: Shumpei MASUDA, Tokyo (JP)

(73) Assignee: SoftBank Group Corp., Tokyo (JP)

(21) Appl. No.: 19/567,289

(22) Filed: Mar. 16, 2026

(30) Foreign Application Priority Data
Mar. 19, 2025 (JP) 2025-045109

(51) Int. Cl. G06F 16/29; G06F 18/15; G06F 18/21; G06N 3/0475

(52) U.S. Cl. CPC G06F 16/29; G06F 18/15; G06F 18/217; G06N 3/0475

(57) ABSTRACT

A system includes a processor that is configured to receive input information from a user, and generate a prompt sentence for instructing a generative AI model to generate a mountaineering plan based on the input information, input the generated prompt sentence into the generative AI model and cause the generative AI model to generate the mountaineering plan, and automatically generate a written plan based on the generated mountaineering plan and submit the written plan to an emergency agency.

### CROSS-REFERENCE TO RELATED APPLICATION

This application is based on and claims priority under 35 USC 119 from Japanese Patent Application No. 2025-045109 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for preparing mountaineering plans largely rely on manual work by the user, including the collection of route information, the assessment of difficulty and risk, the preparation of written plans, and the submission of such written plans to emergency agencies such as police or rescue organizations. This manual process is time consuming, requires expert knowledge, and is prone to human error or omission, such as failure to include necessary information or failure to submit the plan to the appropriate emergency agency. Furthermore, users must separately search for and manage information on regional emergency contacts and facilities, which can result in incomplete or outdated information being used in actual mountaineering activities. In addition, even when position information is acquired by a user's terminal during mountaineering, it is often not systematically recorded and associated with the previously prepared mountaineering plan, which makes it difficult to review and analyze the actual movement route after the mountaineering. Therefore, there is a need for a system that can automatically generate an appropriate mountaineering plan using a generative AI model based on user input information, automatically generate and submit a written plan to emergency agencies, provide the user with regional emergency information associated with the mountaineering plan, and record the actual movement route during mountaineering for later review.

### SUMMARY

In order to solve the above problems, an aspect of the present invention provides a system comprising a processor, wherein the processor is configured to receive input information from a user, and generate a prompt sentence for instructing a generative AI model to generate a mountaineering plan based on the input information, input the generated prompt sentence into the generative AI model and cause the generative AI model to generate the mountaineering plan, and automatically generate a written plan based on the generated mountaineering plan and submit the written plan to an emergency agency. The processor is further configured to acquire information on regional emergency contacts and facilities based on the mountaineering plan and provide the information to the user, thereby enabling the user to readily obtain reliable emergency information linked to the specific mountaineering plan without separate manual searching. In addition, the processor is configured to periodically acquire position information from a terminal of the user and create a record of a movement route after completion of the mountaineering, thereby allowing the user to review and analyze the actual movement route in association with the mountaineering plan. By these means, the system reduces the burden on the user in preparing and submitting mountaineering plans, improves the reliability and completeness of emergency-related information, and facilitates safe mountaineering and post-mountaineering review.

The term “system” refers to an assembly including at least one processor and, optionally, one or more memories, communication interfaces, user terminals, and external services, which cooperatively perform the processing defined in the claims.

The term “processor” refers to one or more hardware processing circuits, such as a central processing unit (CPU), a graphics processing unit (GPU), an application specific integrated circuit (ASIC), or a programmable logic device, capable of executing instructions to perform the functions described in the claims.

The term “user” refers to a person who intends to perform mountaineering and who provides input information to the system and receives mountaineering plans, emergency information, and movement route records from the system.

The term “input information” refers to information provided by the user to the system, including at least one of a desired mountain, a desired mountaineering date, a desired difficulty level, a mountaineering style, the number of days, the number of participants, and optional remarks relevant to a mountaineering plan.

The term “generative AI model” refers to a machine learning model, such as a large language model or other generative model, that is trained on data and configured to generate text or other structured content in response to an input prompt.

The term “prompt sentence” refers to a text string or structured textual instruction generated by the processor and input to the generative AI model in order to cause the generative AI model to generate a mountaineering plan.

The term “mountaineering plan” refers to information generated by the generative AI model and including at least one of a route, a schedule, recommended equipment, risk information, and other planning details for a mountaineering activity.

The term “written plan” refers to a document generated by the processor based on the mountaineering plan, the document including information required by an emergency agency, such as identification of the mountain, schedule, route, participant information, and contact information, and being suitable for submission to the emergency agency.

The term “emergency agency” refers to an organization that receives mountaineering plans or responds to emergencies related to mountaineering, including at least one of a police station, a fire department, a mountain rescue organization, or an equivalent public safety institution.

The term “regional emergency contacts and facilities” refers to contact information and facility information for emergency-related entities located in a region corresponding to the mountaineering plan, including at least one of police stations, hospitals, clinics, rescue centers, and other organizations capable of providing emergency response.

The term “terminal of the user” refers to an electronic device operated by the user, such as a smartphone, tablet, or portable navigation device, which is capable of acquiring position information and communicating the position information to the system.

The term “position information” refers to location data indicating the position of the user's terminal, including at least one of latitude, longitude, altitude, and a timestamp, acquired by a satellite positioning system, cellular positioning, or another location technology.

The term “movement route” refers to a path traveled by the user during mountaineering, which is represented by a sequence of position information items and which can be reconstructed as a continuous route on a map or in another spatial representation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

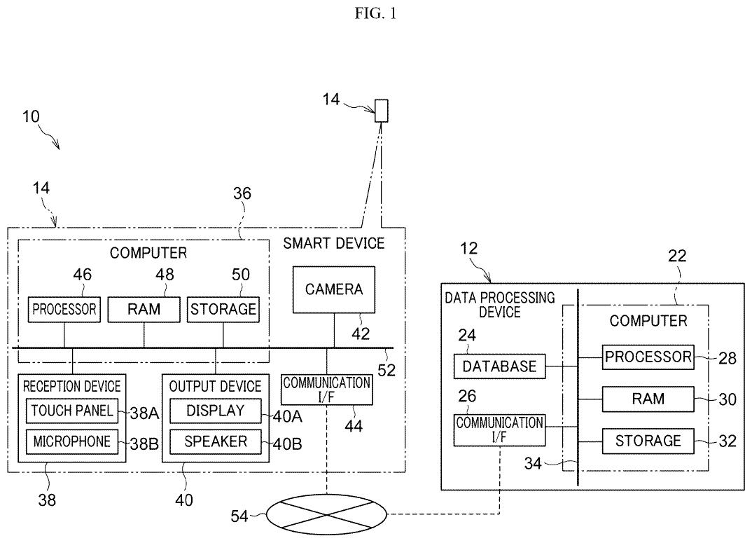

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

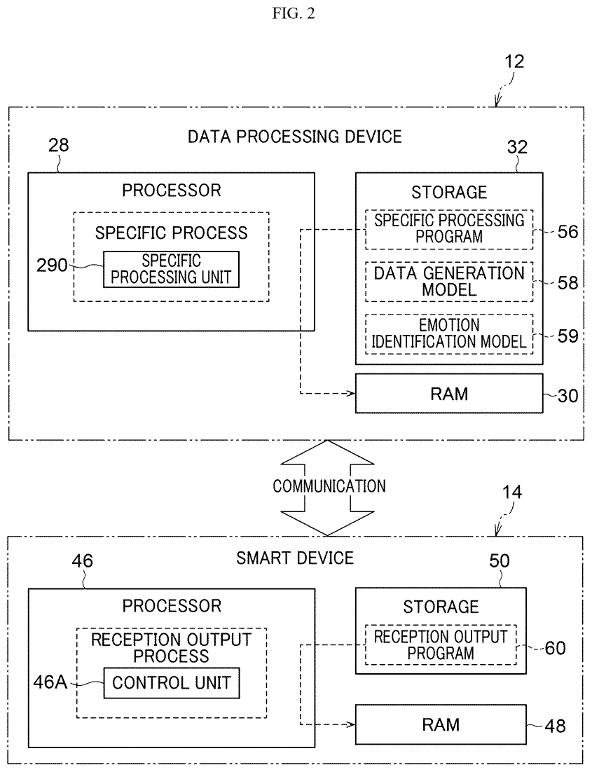

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented route planning systems and electronic form generation systems are typically designed around fixed rule sets and static templates. In such systems, a processor generally applies predefined heuristics to user inputs, such as destination and user attributes, and then fills a fixed document format. As a result, these systems are limited in the type and granularity of plan content that can be generated, and they are not well suited for dynamically producing complex, context-dependent activity plans that integrate route selection, time scheduling, equipment recommendations, weather considerations, and emergency response guidance in a coherent manner.

Furthermore, in conventional architectures, when a user modifies part of a generated plan, such as a departure time or route difficulty, the processor often either applies local adjustments with simplistic recalculation logic or requires the user to regenerate the entire plan manually. This leads to inconsistencies between different parts of the plan, duplication of user operations, and increased processing overhead. In addition, conventional systems do not efficiently integrate external generative AI models, which perform large-scale language processing, with internal structured data processing to attain both flexible natural-language planning and reliable, machine-tractable plan management.

Another issue in existing systems is that emergency contact information and facility information are often managed as independent datasets or static attachments, not tightly coupled to dynamically generated activity plans. The processor typically retrieves such information as a generic list based solely on destination, without taking into account finer-grained region identification derived from the computed plan content. This results in suboptimal or incomplete emergency information, and complicates automatic generation and transmission of electronic documents to public organizations or rescue organizations in a timely and traceable manner.

Moreover, existing systems generally provide the generated plan to the user as an unstructured text block, without transforming the plan into structured data that is classified into route information, time information, equipment information, weather-related information, and emergency response information. This lack of structured representation impairs downstream processing, including selective display on user terminals, efficient updates, and automated comparison between planned and actual movement paths.

Additionally, while some systems may record user location data, they often fail to algorithmically compare the recorded position information with the planned route information to create a robust travel history linked to the original plan document, thereby limiting both safety monitoring and post-activity analysis.

Accordingly, there is a need for an improved computer-implemented system and method that tightly integrates user input acquisition, prompt sentence generation, interaction with a generative AI model, structured plan analysis, dynamic incorporation of region-specific emergency information, iterative plan updating based on user changes, automatic creation and transmission of electronic plan documents, and generation of travel history from position information. Such a system should improve the functioning of the computer by orchestrating these heterogeneous processes in a coordinated, machine-efficient workflow, reducing user burden while enhancing consistency, traceability, and reliability of complex activity plans and associated safety measures.

The specific processing by the specific processing unit 290 of the data processing device 12 in Example 1 is realized by the following means.

The present invention provides a server comprising a processor configured to acquire, from a user operation terminal, input information including destination information, user skill information, activity style information, and condition information; generate base data by associating the input information with geographical information and route information stored in a storage unit; convert the base data into character string data and generate instruction sentence data as a prompt sentence that instructs creation of an activity plan; transmit the instruction sentence data to an external generative AI model and obtain activity plan data including route information, time information, equipment information, and caution information from a text generation process of the generative AI model; extract region identification information based on the activity plan data and acquire corresponding emergency contact information and facility information from at least one of the storage unit and an external information providing apparatus to add the emergency contact information and the facility information to the activity plan data; receive change instructions concerning at least the route information and the time information from the user operation terminal, regenerate the instruction sentence data based on the change instructions, and input the regenerated instruction sentence data to the generative AI model to obtain updated activity plan data; generate plan document data in a predetermined format based on at least one of the activity plan data and the updated activity plan data and based on the emergency contact information and the facility information, and format the plan document data as an electronic document by using a document generation function; transmit the electronic document to at least one of a public organization and a rescue organization via a communication function, store a transmission result as management information, and notify the transmission result to the user operation terminal; and store the activity plan data and the updated activity plan data in association with identification information in the storage unit and provide the activity plan data to the user operation terminal in response to a request from the user operation terminal. This enables a computer system to more efficiently generate, update, structure, and distribute context-rich activity plans and associated safety documents by orchestrating prompt-based interaction with a generative AI model, fine-grained region-specific emergency information integration, and automated document handling in a unified, technically improved processing workflow.

The term “system” refers to an arrangement including at least one server, one or more user operation terminals, one or more storage units, and one or more communication functions that cooperate to perform the processing described in the claims.

The term “server” refers to an electronic information processing apparatus including at least one processor, a memory, and a communication interface, and configured to execute programs for performing the acquisition, generation, analysis, storage, and transmission processes described in the claims.

The term “processor” refers to a hardware computation unit, such as a central processing unit or an equivalent processing circuitry, that executes instructions stored in a memory to perform the functions attributed to the processor in the claims.

The term “storage unit” refers to any non-transitory computer-readable storage medium, such as a semiconductor memory, a magnetic storage device, or an optical storage device, configured to store data including geographical information, route information, activity plan data, and management information.

The term “user operation terminal” refers to an electronic apparatus, such as a portable communication device, a personal computer, or a tablet device, that is operated by a user to input information, receive information from the server, and display information related to an activity plan.

The term “input information” refers to information provided from the user operation terminal to the server, including, but not limited to, destination information, user skill information, activity style information, and condition information that serve as a basis for generating an activity plan.

The term “destination information” refers to information specifying a target location or region for an activity, such as a name or identifier of a mountain, area, or route to be visited.

The term “user skill information” refers to information indicating a proficiency level, experience level, or capability of a user with respect to a particular type of activity.

The term “activity style information” refers to information indicating a style, format, or mode of an activity, such as a day trip, an overnight trip, or a multi-day trip.

The term “condition information” refers to additional constraints or preferences for an activity, including temporal conditions, physical limitations, risk tolerances, or route preferences specified by the user.

The term “geographical information” refers to information representing the physical layout of an area, including coordinates, elevation, terrain types, and other spatial attributes.

The term “route information” refers to information defining one or more paths or courses between locations, including waypoints, trail segments, distances, and relationships between segments.

The term “base data” refers to data generated by associating the input information with the geographical information and the route information in a structured format serving as an intermediate representation for subsequent processing.

The term “character string data” refers to data expressed as sequences of characters, such as text strings, capable of representing instructions, descriptions, or other language-based content.

The term “instruction sentence data” refers to character string data formatted as natural-language instructions that direct a generative AI model to generate, modify, or refine an activity plan.

The term “prompt sentence” refers to an instruction sentence data instance used as an input to a generative AI model to control or guide the model's output.

The term “generative AI model” refers to a machine learning model having a language processing function that generates text or other data based on an input prompt, using internal parameters trained on large-scale data.

The term “language processing function” refers to a functionality of an artificial intelligence model that interprets, analyzes, and generates human-readable text based on input text data.

The term “text generation process” refers to a computational process performed by the generative AI model to output natural-language text in response to input instruction sentence data.

The term “activity plan data” refers to data generated, at least in part, by the generative AI model, including information about routes, times, equipment, cautions, and other plan components related to an activity.

The term “route information” in the context of activity plan data refers to a portion of the activity plan data that specifies one or more recommended paths, starting points, waypoints, and endpoints for the activity.

The term “time information” refers to a portion of the activity plan data that specifies times or time intervals, including departure times, arrival times, and durations for segments of an activity.

The term “equipment information” refers to a portion of the activity plan data that specifies items recommended or required for the activity, such as clothing, tools, food, and safety equipment.

The term “caution information” refers to a portion of the activity plan data that specifies warnings, risks, or precautions to be taken during the activity.

The term “region identification information” refers to information derived from at least the activity plan data and indicating a target region, area, or zone to be used when retrieving region-specific data such as emergency contact information.

The term “emergency contact information” refers to information relating to contact points for assistance in an emergency, including identifiers and communication endpoints for emergency services or support organizations.

The term “facility information” refers to information about facilities relevant to an activity, including, for example, locations and contact points of police stations, fire stations, medical institutions, shelters, or other support facilities.

The term “external information providing apparatus” refers to an apparatus or service, located outside the server, that provides data such as region information, emergency contact information, or facility information via a communication network.

The term “change instructions” refers to instructions received from the user operation terminal that request modification of at least part of the activity plan data, including changes to route information, time information, or other plan parameters.

The term “updated activity plan data” refers to activity plan data newly obtained by the server from the generative AI model based on regenerated instruction sentence data that reflects change instructions.

The term “plan document data” refers to data representing an activity plan and associated information in a structured format suitable for conversion into a document, including layout, sections, and fields.

The term “predetermined format” refers to a predefined document structure that specifies arrangement, headings, fields, and layout rules for representing the plan document data.

The term “document generation function” refers to a software or hardware function that converts plan document data into an electronic document format, such as a portable document format or another standardized document format.

The term “electronic document” refers to a digital representation of a document, capable of being stored, transmitted, and displayed by electronic devices, including visualization of plan contents and related information.

The term “communication function” refers to hardware, software, or a combination thereof that allows the server to send and receive data over a communication network, including transmission of electronic documents and reception of input information.

The term “public organization” refers to an organization responsible for administrative or public safety services, such as a governmental office, a local authority, or a public safety agency.

The term “rescue organization” refers to an organization responsible for providing emergency rescue or relief services, such as a rescue team, an emergency response center, or a search and rescue unit.

The term “transmission result” refers to information indicating a status of transmission of an electronic document, including success, failure, or other outcome data associated with the communication.

The term “management information” refers to information stored by the server for managing operations, including transmission results, timestamps, identifiers, and other metadata related to processing steps.

The term “identification information” refers to information, such as a unique identifier or label, used to associate activity plan data, updated activity plan data, or travel history data with a specific activity or document.

The term “position information” refers to information indicating a geographical position of a user operation terminal, including, for example, coordinates obtained from a satellite positioning system or other location-detection mechanism.

The term “time series” refers to an ordered set of data points, such as position information, indexed or recorded over time to represent temporal changes.

The term “travel history data” refers to data that represents an actual movement path of a user, generated by comparing accumulated position information with planned route information, and used for analysis or record-keeping of the activity.

The term “plan document data” in association with travel history refers to plan document data linked to travel history data to enable comparison between planned activities and actual activities.

In one embodiment, a server executes a computer program stored in a non-transitory computer-readable storage medium to implement the claimed system. The server includes at least one processor, a main memory, a storage unit such as a magnetic disk device or a solid-state drive, and a network interface connected to a communication network. The server operates under an operating system such as a general-purpose server operating system, and executes application software implemented, for example, using a web framework such as a scripting-language framework or a strongly typed language framework. The server communicates with one or more terminals via a network using a protocol such as HTTPS.

The terminal includes, for example, a portable communication device, a tablet device, or a personal computer. The terminal includes a processor, a memory, a display, an input device such as a keyboard and a pointing device or touch panel, and a communication interface. The terminal executes an application or a web browser and displays a graphical user interface that enables a user to input information for an activity plan, such as a hiking plan. The user operates the terminal to select or enter destination information, user skill information, activity style information, condition information, and other relevant parameters.

The server generates and deploys a program that implements an activity plan generation module, a prompt sentence generation module, a generative AI interface module, an activity plan analysis module, an emergency information integration module, a plan document generation module, a transmission management module, and a travel history generation module. Each module is realized as software components executed by the processor and exchanging data via defined data structures stored in the memory and the storage unit.

The server uses a structured internal data model for representing user input information and related reference information. The server stores geographical information and route information in a relational database system such as a general-purpose relational database, which includes tables for mountain or region identifiers, trailhead coordinates, waypoints, route segments, typical durations, elevation changes, and seasonal constraints. The server stores these tables on a storage unit, and the processor accesses them using database access software such as an object-relational mapping library.

The server, upon receiving input information from the terminal, performs data association processing to generate base data. The server represents the base data as a composite data structure that includes fields for destination identifiers, user skill level codes, activity style codes, and references to route records and geographical features obtained from the database.

The server normalizes the input information by mapping free-text entries to internal identifiers and codes. This normalization reduces ambiguity and enables consistent downstream processing.

The server converts the base data into character string data to form a prompt sentence. The server uses a prompt sentence generation module that applies a template-based transformation algorithm. The server constructs the prompt sentence by inserting field values from the base data into one or more template strings, while also adding explicit requirements about structure and content of the desired output. For example, the server generates a prompt sentence such as:

“Create a safe, detailed, one-day hiking plan for a designated mountain for an intermediate hiker in early September. Include recommended starting point, specific route description, approximate times for each segment, total hiking duration, required equipment and clothing, recommended food and water amounts, weather and temperature considerations, altitude sickness precautions, and basic emergency actions. Output the plan in clear bullet points, grouped by sections: Route, Schedule, Equipment, Weather, Emergency precautions.”

The server may further generate a revision prompt sentence when the user requests changes, for example:

“Based on the following existing hiking plan for an intermediate hiker, adjust the schedule so that departure is at 4:30 a.m., summit arrival is before 11:00 a.m., and the total hiking duration remains 8 to 9 hours. Keep the same route if it remains safe. Update only the times and any equipment or safety recommendations that are affected by the earlier start. Present the updated plan with a short summary of what has changed.”

The server uses these prompt sentences as instruction sentence data for a generative AI model. The server connects to an external generative AI model via an application programming interface exposed by a model service provider. The generative AI model is implemented as a deep neural network, for example a transformer-based language model. The neural network includes multiple layers of self-attention and feed-forward units, with learned weight matrices and bias vectors stored in the model infrastructure. The model has been pre-trained on large text corpora by minimizing a loss function such as cross-entropy loss between predicted token probabilities and actual next tokens in training sequences, using gradient-based optimization methods such as stochastic gradient descent with variants of adaptive learning rate algorithms. During training, the model updates its parameters by computing gradients of the loss function with respect to each weight, performing backpropagation across layers, and adjusting weights to reduce prediction error.

The server, when interfacing with the generative AI model, supplies the prompt sentence as a sequence of tokens drawn from a vocabulary. The generative AI model internally encodes the tokens into vectors, processes them through attention layers that compute weighted context across the sequence, and outputs next-token probability distributions. The model then samples or selects tokens according to decoding parameters such as temperature and top-k or nucleus sampling thresholds to generate the response text. This architectural design and training approach allow the model to produce coherent and context-rich activity plans that consider interactions among multiple constraints encoded in the prompt.

The server improves computer-implemented planning beyond simple automation of human tasks by tightly constraining and structuring the interaction with the generative AI model. The server does not merely delegate free-form text generation; instead, the server performs a sequence of transformations and validations around the model call. The server encodes domain-specific constraints in the prompt sentence, uses internal data schemas to capture the output in structured form, and performs deterministic post-processing algorithms that detect and correct inconsistencies between generated content and stored reference data. This hybrid approach combines neural text generation with rule-based validation, thereby increasing accuracy and consistency of the final plan compared to either human drafting or naive AI usage.

The server, after receiving activity plan data from the generative AI model, applies an activity plan analysis module to transform unstructured text into structured data. The server executes a parsing algorithm that uses a combination of token patterns, section headings, and delimiter rules to segment the text into sections for route information, time information, equipment information, weather-related information, and emergency response information. The server may additionally use a secondary language model instance configured as a classifier to tag sentences with section labels, using features such as token n-grams, positional indices, and part-of-speech tags. The server then stores the structured data in normalized tables and JSON fields, linked to plan identifiers.

The server reduces processing complexity and communication load by sending only compact structured summaries back to the terminal when appropriate, instead of the entire unstructured text, and by caching intermediate results. For example, the server stores the original AI-generated text once, and then transmits only incremental updates or structured components when the user requests revisions. This design minimizes network bandwidth and improves responsiveness.

The server integrates emergency contact information and facility information by deriving region identification information from the activity plan data. The server analyzes specific tokens in the generated text that refer to regions, trailheads, or waypoints, and maps them to internal region codes using a lookup table. The server then queries an emergency information database keyed by these region codes to retrieve contact numbers, facility names, and addresses for local police, fire departments, rescue stations, and medical facilities. By basing region identification on the plan content rather than only on the original destination input, the server obtains more precise emergency data that corresponds to actual planned routes and elevations.

The server uses a plan document generation module to convert structured plan data and emergency information into plan document data in a predetermined format. The server constructs a data structure that represents document sections, tables, headers, and footers, and then passes this structure to a document generation engine. The server uses a layout algorithm that calculates positions of text blocks and table cells, paginates content, and embeds metadata such as timestamps and user identifiers. The server outputs an electronic document in a standardized format such as a portable document format file. The server stores a reference to the document in the storage unit and associates the document with the underlying structured plan data.

The server transmits the electronic document to public organizations or rescue organizations via a communication interface. The server uses standardized protocols such as email over simple mail transfer protocol, or application interfaces provided by emergency information systems. The server records transmission status codes, response messages, and timestamps as transmission result records in the storage unit. The server then notifies the terminal of the transmission result. This closed-loop design enables the user to confirm that emergency preparedness documents have been successfully delivered.

The terminal displays the structured activity plan data to the user by dividing information into separate views for route, schedule, equipment, weather, and emergency measures. The terminal renders checklists, time-line visualizations, and map overlays using map service software development kits. The user uses the terminal interface to request adjustments to departure times, target completion times, route difficulty levels, and safety margins.

The server, upon receiving adjustment instructions, updates the base data and generates a revised prompt sentence that references both the existing plan and the new constraints.

Because the server maintains the plan internally as structured data, the server can automatically detect which components require recalculation and can explicitly instruct the generative AI model to adjust only those components. This targeted revision reduces the computational overhead compared to regenerating the entire plan, and also reduces the likelihood of introducing inconsistencies. The server may embed constraints in the revised prompt sentence, such as maximum total duration, earliest or latest allowable times, or prohibited route segments, to guide the generative AI model away from solutions that would violate user preferences or safety constraints.

The server improves computational efficiency by controlling the size of prompt sentences and by reusing context tokens. For example, the server may summarize unchanged sections of the plan and include them in compressed form when requesting specific adjustments. The server may also pre-encode frequently used instruction templates and shared domain constraints, reducing tokenization overhead at the model interface. These techniques lead to reduced latency and reduced computational resource consumption at the model infrastructure, thereby improving system performance.

The server also generates travel history data by comparing planned route information with position information acquired from the terminal. The terminal periodically measures its location using a positioning module and transmits coordinate data with timestamps to the server. The server stores the position information in time series form and applies a path-matching algorithm that maps the recorded positions onto planned route segments. The server computes deviations, delays, and velocity patterns, and produces a travel history that indicates which parts of the planned route were followed and how actual times compared to planned times. The server associates the travel history with the plan document data in the storage unit.

The server, by linking real-time or recorded position information with the planned route at a fine granularity, enables improved safety and analysis functions that are not available in conventional, purely paper-based planning. For example, the server can detect prolonged stops in high-risk segments or significant deviations from planned paths and may trigger alerts or recommendations. This linkage between structured plans and measured movement data contributes to improved technical functionality in the area of location-based services.

In another embodiment, the server uses an alternative generative AI model or multiple models. For example, the server may use a first model trained for route and schedule generation and a second model trained for risk and emergency description generation. The server can decompose a prompt sentence into sub-prompts targeted to each model, then merge the outputs into a unified structured plan. The server may use distinct decoding parameters or model configurations to optimize for factual accuracy in time and distance estimates versus richness of natural-language explanation. This modular architecture allows the server to adjust the trade-off between computational cost and output quality according to system conditions.

In a further embodiment, the server maintains a feedback module that continuously evaluates differences between generated plans and actual travel histories. The server computes error metrics such as deviation between predicted and actual segment times, and distribution of deviations across different terrain types and user skill levels. The server uses this feedback to adjust prompt templates and domain constraints so that future prompt sentences emphasize aspects that historically caused errors. For example, if the system detects that certain route segments are consistently underestimated in time, the server modifies the templates to highlight caution and extra buffer time in those segments, thereby improving subsequent plan accuracy without retraining the underlying model.

The server, by integrating these modules into a coherent processing pipeline, improves the functioning of the computer system as a whole. The server uses specialized data structures for base data, structured plan data, emergency contact data, document layout data, and travel history data, and coordinates their transformations in a defined order. This design yields technical effects such as reduced manual data entry, reduced duplication of processing, improved consistency and traceability of generated documents, and enhanced ability to monitor and analyze adherence to plans. The combination of rule-based pre- and post-processing around the generative AI model, structured internal representations, and multi-stage validation produces more accurate and reliable planning outputs than conventional systems that rely solely on static templates or unstructured human drafting.

The terminal, by rendering structured plan components and accepting fine-grained change instructions, supports a human-machine interaction pattern that allows the server to apply its computational advantages effectively. The user, by using the terminal interface, benefits from detailed, dynamically adjustable plans and integrated emergency information, while the underlying computer system performs optimized data management, neural text generation, and structured document handling that extend beyond mere automation of human planning steps.

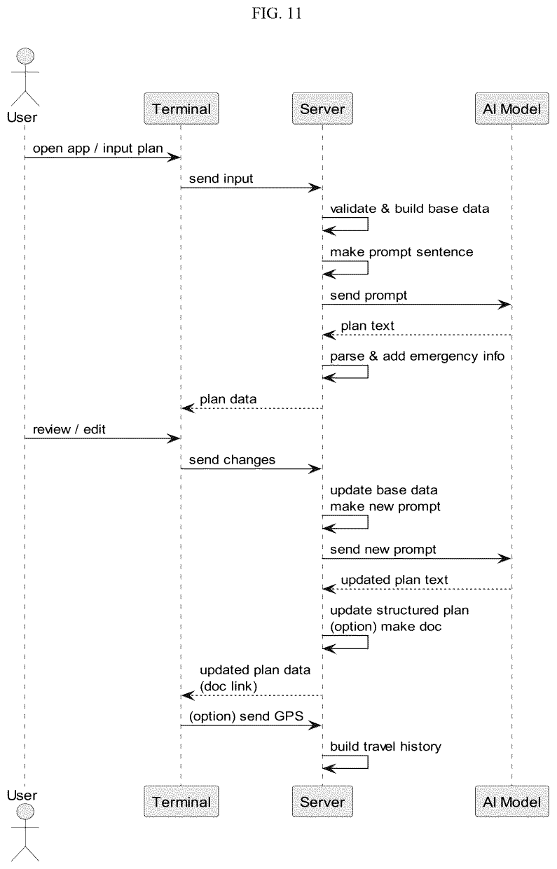

The following describes the processing flow using FIG. 11.

### Step 1:

The user operates the terminal to launch an application or web page that provides an activity planning interface. The terminal displays input fields for destination, user skill level, activity style (such as day trip or overnight), desired date, and additional conditions (such as “avoid steep routes”).

Input: No prior data; the terminal loads layout and configuration data from local storage or from the server.

Output: A graphical user interface that allows the user to enter planning parameters.

The terminal renders buttons, drop-down lists, text boxes, and checkboxes. The terminal requests configuration data (such as selectable skill levels and activity styles) from the server via a network request and uses this data to populate selection controls.

### Step 2:

The user enters destination information, user skill information, activity style information, and condition information using the input fields on the terminal. The terminal performs basic validation, such as checking that the destination field is not empty and that the planned date has a valid format.

Input: User keystrokes and touch inputs specifying destination, skill level, activity style, date, and conditions.

Output: A local structured representation of input information, for example a key-value mapping stored in memory on the terminal.

The terminal converts the user's entries into internal variables, updates the display to show the current selection, and highlights any invalid fields that must be corrected before submission.

### Step 3:

The terminal sends the input information to the server via a network interface. The terminal serializes the input information into a structured message (for example, a JSON object) and transmits it to an application programming interface endpoint on the server using a secure protocol.

Input: Structured input information stored in the terminal's memory.

Output: A network request message containing the input information delivered to the server, and a local record of the submission status maintained on the terminal.

The terminal attaches authentication data, such as a token, to the request headers and starts a timer to measure response time.

### Step 4:

The server receives the network request and parses the structured input information. The server validates that required fields such as destination and activity style are present and maps free-form text entries to internal codes using lookup tables stored in the storage unit.

Input: The network request message containing user input information.

Output: Base input records in server memory with normalized destination codes, skill level codes, activity style codes, and condition flags.

The server performs data processing by applying pattern-matching functions to the destination text, querying a database for matching identifiers, and assigning a canonical destination identifier to the input. The server rejects or flags records that do not match any known destination and may request clarification from the terminal.

### Step 5:

The server retrieves geographical information and route information corresponding to the normalized destination and other parameters. The server executes database queries to obtain trailhead coordinates, waypoints, route segments, typical durations, elevation profiles, and recommended seasons.

Input: Normalized destination identifiers and user parameters held in server memory.

Output: Base data that associates the user's input information with specific geographical and route records from the database.

The server performs join operations between tables containing region identifiers and route segments, filters segments based on skill level and activity style constraints, and stores the selected segments as part of the base data structure.

### Step 6:

The server converts the base data into character string data and generates a prompt sentence. The server uses a prompt generation module that inserts field values such as destination name, skill level description, and activity style into a template string and adds explicit output requirements.

Input: Base data including destination identifiers, skill level, activity style, and selected route candidates.

Output: Instruction sentence data formatted as a prompt sentence for a generative AI model.

The server performs data processing by concatenating textual fragments, converting internal codes to human-readable descriptions, and appending constraints and section headings to guide the model. An example prompt sentence is: “Create a safe, detailed, one-day hiking plan for a designated mountain for an intermediate hiker in early September. Include recommended starting point, specific route description, approximate times for each segment, total hiking duration, required equipment and clothing, recommended food and water amounts, weather and temperature considerations, altitude sickness precautions, and basic emergency actions. Output the plan in clear bullet points, grouped by sections: Route, Schedule, Equipment, Weather, Emergency precautions.”

### Step 7:

The server sends the prompt sentence to an external generative AI model through an interface module. The server tokenizes the prompt sentence, encodes it according to the model's input format, and transmits it via a network request to the model service.

Input: Prompt sentence generated from base data.

Output: A model request that includes tokenized text and model parameters, and a pending state waiting for a model response.

The server applies parameter settings such as maximum output length and decoding strategy in the request body, and uses a secure network protocol to protect the content in transit.

### Step 8:

The generative AI model, implemented as a trained neural network, receives the tokenized prompt and performs a sequence of numerical computations. The model embeds tokens into vectors, applies multiple attention layers and feed-forward layers, and produces probability distributions for output tokens.

Input: Encoded prompt tokens and model parameters.

Output: A sequence of output tokens that represent the generated activity plan text.

The model executes linear algebra operations, such as matrix multiplications, vector additions, and nonlinear activation functions, according to its stored weights and biases. The model selects or samples output tokens based on these probability distributions to form text that describes a route, schedule, required equipment, and safety instructions.

### Step 9:

The server receives the response from the generative AI model and reconstructs the generated text. The server decodes tokens into character strings and consolidates them into continuous text paragraphs or bullet lists.

Input: Output token sequence produced by the generative AI model.

Output: Raw activity plan text that includes route descriptions, times, equipment lists, and cautionary notes.

The server checks for errors, such as incomplete responses or excessive length, and may request a regeneration from the model if the output does not satisfy minimum completeness criteria.

### Step 10:

The server analyzes the raw activity plan text and converts it into structured activity plan data. The server applies parsing rules that detect section headings, bullet markers, time expressions, and named locations.

Input: Raw activity plan text produced by the generative AI model.

Output: Structured activity plan data divided into route information, time information, equipment information, weather-related information, and emergency response information.

The server uses pattern recognition algorithms, such as regular expressions and text segmentation heuristics, to identify time phrases and location names. The server stores each identified element as entries in data structures, for example arrays or lists indexed by section type.

### Step 11:

The server extracts region identification information from the structured activity plan data.

The server matches place names and route references in the plan against entries in a region mapping table.

Input: Structured activity plan data with route and location descriptions.

Output: Region identification codes that represent specific areas and sub-regions relevant to the planned activity.

The server performs database lookups using location names and coordinates found in the plan text, resolves ambiguities by selecting regions that best match the combination of trailheads and waypoints, and stores the identified region codes in association with the plan.

### Step 12:

The server acquires emergency contact information and facility information corresponding to the region identification codes. The server queries an emergency information database or requests data from an external information provider.

Input: Region identification codes linked to the activity plan.

Output: A set of emergency contact records and facility records that include contact numbers, facility names, and types.

The server filters emergency entries by type (e.g., police, fire, medical), ranks them by distance or priority, and attaches the selected records to the activity plan data structure.

### Step 13:

The server integrates the structured activity plan data with the emergency contact information and facility information. The server merges data fields into a unified plan representation.

Input: Structured activity plan data and emergency/facility records.

Output: Enhanced activity plan data that includes both planning details and region-specific safety resources.

The server performs data processing by adding nested structures or linked lists under the plan node, and updates indexes so that each segment of the route can be associated with nearby emergency facilities if needed.

### Step 14:

The server stores the enhanced activity plan data in the storage unit with a unique plan identifier and metadata such as creation time and user identifier. The server writes records into database tables and commits the transaction.

Input: Enhanced activity plan data and user identification information.

Output: Persistent plan records that can be retrieved and updated later.

The server generates a unique identifier, inserts plan data into relational tables or serialized fields, and records a mapping from the identifier to the user's account.

### Step 15:

The server sends the structured and enhanced activity plan data to the terminal. The server formats the data as a response message and transmits it over the network.

Input: Persistent plan data and plan identifier stored in the server.

Output: A response message containing the plan identifier, structured plan sections, and emergency information delivered to the terminal.

The server may compress the data to reduce communication load and include flags indicating which sections should be initially displayed.

### Step 16:

The terminal receives the activity plan data and renders it on the display. The terminal separates the information into dedicated views, such as route details, schedule table, equipment checklist, weather notes, and emergency contacts.

Input: Response message from the server containing structured plan data.

Output: Visual representations of the plan sections and interactive controls on the terminal's display.

The terminal generates user interface components such as list views, maps, time-line charts, and toggle switches. The terminal also stores the plan data locally to support offline viewing when network connection is limited.

### Step 17:

The user reviews the displayed plan and, if necessary, requests adjustments. The user may change the desired departure time, maximum total hiking duration, or acceptable difficulty level, using sliders, date-time pickers, or selection lists on the terminal.

Input: Displayed plan content and interactive controls.

Output: Modified parameter values representing adjustment instructions entered by the user.

The terminal updates internal variables as the user changes values and visually reflects the new settings, for example by highlighting changed fields or displaying a summary of requested modifications.

### Step 18:

The terminal sends the adjustment instructions to the server. The terminal creates a message that includes the plan identifier and the modified parameters, then transmits it via the network.

Input: Modified parameter values stored on the terminal.

Output: A network request message containing adjustment instructions delivered to the server.

The terminal ensures that only changed fields are included to minimize data size and includes a version number of the plan to prevent conflicts.

### Step 19:

The server receives the adjustment instructions and updates the base data. The server applies the changes to the stored plan parameters and determines which parts of the plan need to be recalculated.

Input: Adjustment instructions and previously stored base data for the plan.

Output: Updated base data reflecting new constraints and revised requirements.

The server performs logical comparisons between old and new values, marks affected sections (for example, schedule and equipment), and leaves unchanged sections (for example, destination) intact.

### Step 20:

The server generates a revised prompt sentence that references the existing plan and incorporates the adjustment instructions. The server includes a summary of the current plan and explicit constraints for the desired changes.

Input: Updated base data and previously generated plan text.

Output: A revised prompt sentence for the generative AI model.

The server constructs text such as: “Based on the following existing hiking plan for an intermediate hiker, adjust the schedule so that departure is at 4:30 a.m., summit arrival is before 11:00 a.m., and the total hiking duration remains 8 to 9 hours. Keep the same route if it remains safe. Update only the times and any equipment or safety recommendations that are affected by the earlier start. Present the updated plan with a short summary of what has changed.” The server concatenates this with a truncated or summarized version of the current plan text to keep the input length manageable.

### Step 21:

The server sends the revised prompt sentence to the generative AI model and obtains updated plan text. The server again encodes the prompt, transmits it, and receives new output tokens from the model.

Input: Revised prompt sentence and existing plan context.

Output: Updated activity plan text that reflects the requested changes.

The server sets model parameters to prioritize consistency with the previous plan, such as restricting length and encouraging minimal modifications, then decodes the returned tokens into human-readable text.

### Step 22:

The server analyzes the updated plan text and updates the structured activity plan data. The server compares the new text with the previous structured data, identifies modified schedule entries and equipment recommendations, and replaces or adds entries accordingly.

Input: Updated activity plan text and prior structured plan data.

Output: Revised structured plan data with clear identification of changed items.

The server uses text comparison algorithms and section labels to detect differences, marks changed fields with update flags, and stores a new version entry in the database while retaining a link to the previous version.

### Step 23:

The server regenerates or updates plan document data and, if requested, regenerates the electronic document. The server reconstructs document sections, tables, and headers to reflect the updated plan and emergency information.

Input: Revised structured plan data and existing plan document data.

Output: New or updated plan document data and, if executed, a revised electronic document.

The server runs a layout routine that recomputes pagination and adjusts table contents, then writes the updated electronic document to storage and updates the reference in the plan record.

### Step 24:

The server sends the updated structured plan and, where appropriate, updated document references to the terminal.

Input: Revised structured plan data and electronic document metadata.

Output: A response message to the terminal that includes updated sections and version information.

The server annotates changed fields in the response so that the terminal can visually highlight the modifications for the user.

### Step 25:

The terminal receives the updated plan data and refreshes the display. The terminal updates the schedule, route details, and equipment list, and marks changed items using visual cues such as color or icons.

Input: Response message with revised plan sections and change indicators.

Output: An updated user interface that reflects the new plan version and emphasizes the differences.

The terminal may show a version label and last-updated timestamp, and optionally provide a toggle for the user to compare the current plan with the previous version.

### Step 26:

The terminal periodically acquires position information while the user is performing the activity, if the user permits tracking. The terminal uses a location sensor to obtain geographic coordinates with timestamps and transmits these to the server at intervals.

Input: Sensor measurements of position and time on the terminal.

Output: Position data streams sent to the server at defined time steps.

The terminal aggregates multiple readings, performs basic filtering to remove outliers, and batches them into update messages to reduce communication overhead.

### Step 27:

The server receives the position data streams and generates travel history data by comparing recorded positions with planned route segments. The server applies a path-matching algorithm that assigns each recorded position to the nearest planned route segment within a distance threshold.

Input: Time-stamped position data and planned route information from the structured plan.

Output: Travel history data that includes actual path, segment times, and deviations from the plan.

The server computes differences between actual and planned times for each segment, identifies detours or prolonged stops, and stores the travel history linked to the plan identifier.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems for planning services such as meals or deliveries typically rely on static rule sets, manually defined filters, or predefined ranking logic. In such systems, a server generally applies hard-coded matching conditions between user input and stored provider data, and then executes fixed database queries. As a result, these systems exhibit limited flexibility in interpreting complex or ambiguous user requirements, are unable to automatically refine search and evaluation criteria in response to nuanced user constraints, and require substantial manual engineering effort to support new types of plans or conditions.

Furthermore, in many existing architectures, a generative AI model, if used at all, is only employed to generate natural language suggestions or descriptive text, while the core computation for selecting providers and plans remains decoupled from the AI output. In such configurations, the AI output is not transformed into structured, machine-usable parameters that directly control database search conditions and scoring functions. This separation leads to inefficient use of computational resources, since the server must perform additional ad hoc parsing or human-in-the-loop adjustments, and often results in suboptimal or inconsistent plan generation.

In addition, known systems generally treat user modifications to a proposed plan as isolated transactions, applying incremental changes to the latest result without revisiting the upstream analysis pipeline. This approach prevents iterative, end-to-end refinement of the planning process, and fails to leverage previous and updated user inputs in a unified manner.

Consequently, the server cannot fully adapt query parameters, evaluation indices, and ranking logic to evolving user preferences, leading to degraded accuracy and responsiveness of the recommendation process.

Accordingly, there is a need for an improved computer-implemented technique in which a server systematically uses a generative AI model, via explicitly constructed prompt sentences, as an integral part of the data-processing pipeline. There is a further need for a mechanism by which the server converts the analysis result of the generative AI model into structured information that directly defines search conditions and evaluation indices for stored provider and item data. There is also a need for iterative normalization and re-generation of prompt sentences and plans in response to user-driven condition changes, so that the entire computation—from user input through AI analysis and database evaluation—can be dynamically reconfigured and optimized. Such improvements are expected to enhance the efficiency, adaptability, and technical performance of the server-side planning system, thereby providing a concrete improvement in computer technology for plan generation and recommendation.

The specific processing by the specific processing unit 290 of the data processing device 12 in Application Example 1 is realized by the following means.

The present invention provides a server comprising a processor and a storage device, the processor being configured to receive input information including preference conditions and constraint conditions of a user from a user terminal, generate a prompt sentence for instructing a generative AI model to generate a service provision plan based on the input information, input the prompt sentence to the generative AI model, convert an analysis result obtained from the generative AI model into structured information, dynamically set, using the structured information, search conditions and evaluation indices for service provider information and service item information stored in the storage device, execute database search processing and evaluation processing based on the search conditions and the evaluation indices to generate the service provision plan that satisfies the preference conditions and the constraint conditions of the user, output the generated service provision plan to a display device for the user, receive, from the user terminal, input for condition change or plan modification, normalize the input information again in response to the input for the condition change or the plan modification, regenerate a new prompt sentence reflecting a result of the normalization, re-input the new prompt sentence to the generative AI model to iteratively update the service provision plan, and generate and transmit order information corresponding to selection content based on the service provision plan to an external provision service. This enables the generative AI model to be integrated as a functional component of the server-side data processing pipeline, allows AI-derived analysis results to directly control database-level search and ranking operations through structured parameters, supports iterative, end-to-end refinement of plans in response to user interactions, and thereby improves the efficiency, adaptability, and technical performance of computer-implemented service plan generation.

The term “processor” refers to a hardware and/or software computation element, such as a central processing unit or an execution core, configured to execute instructions for performing data processing operations described in the present specification.

The term “storage device” refers to a hardware memory component, such as a volatile memory or a non-volatile memory, configured to store programs, data, service provider information, service item information, and intermediate processing results for access by the processor.

The term “user” refers to an operator, such as a human individual, who provides input information including preference conditions and constraint conditions, and who views or selects a service provision plan generated by the system.

The term “user terminal” refers to an information processing apparatus, such as a mobile device, a portable terminal, or a personal computer, operated by the user to transmit input information to the server and to receive and display the service provision plan.

The term “display device” refers to a presentation component, which may be integrated with or connected to the user terminal, configured to visually output a service provision plan and related information to the user.

The term “input information” refers to data supplied by the user, including at least preference conditions and constraint conditions, and optionally including additional parameters used by the processor to generate or refine a service provision plan.

The term “preference conditions” refers to conditions representing desired attributes or qualitative tendencies of the user, such as types of services, categories of items, or qualitative preferences to be reflected in the service provision plan.

The term “constraint conditions” refers to conditions representing quantitative or restrictive requirements of the user, such as budget limits, time limits, geographic limits, or exclusion conditions that must be satisfied by the service provision plan.

The term “generative AI model” refers to a machine-learned information processing model, such as a neural network-based language model, configured to generate output data including analysis results in response to a prompt sentence supplied by the processor.

The term “prompt sentence” refers to a sequence of symbols, such as a natural language text string, generated by the processor to describe input information and to instruct the generative AI model to perform analysis for generating or supporting generation of a service provision plan.

The term “analysis result” refers to output data produced by the generative AI model in response to the prompt sentence, including interpretations, recommendations, or derived conditions usable by the processor for further processing.

The term “structured information” refers to data obtained by converting the analysis result of the generative AI model into a machine-readable format having predefined fields or structure, such as key-value pairs, tables, or records, suitable for controlling database processing and evaluation processing.

The term “service provider information” refers to data stored in the storage device that describes entities capable of providing services, such as providers' identifiers, categories, attributes, locations, availability conditions, and evaluation values.

The term “service item information” refers to data stored in the storage device that describes units of services or items offered by service providers, such as item identifiers, categories, prices, time requirements, and attribute information.

The term “service provision plan” refers to a plan generated by the processor, including at least one combination of a service provider and one or more service items, that is selected such that the combination satisfies the preference conditions and the constraint conditions of the user.

The term “search conditions” refers to conditions derived from the structured information or input information, which are used by the processor to specify criteria for database search processing on the service provider information and the service item information.

The term “evaluation indices” refers to numerical or categorical parameters used by the processor for scoring or ranking service providers and service items, based on attributes such as suitability, rating, cost, time, or other criteria derived from the structured information or input information.

The term “database search processing” refers to processing in which the processor, using the search conditions, accesses the storage device and retrieves service provider information and service item information that satisfy the search conditions.

The term “evaluation processing” refers to processing in which the processor applies the evaluation indices to search results to compute evaluation values, scores, or rankings for candidate combinations of service providers and service items.

The term “condition change” refers to a modification of at least one preference condition or constraint condition, or an addition or deletion of such a condition, as input by the user after presentation of a service provision plan.

The term “plan modification” refers to user input that changes a structure or content of an already generated service provision plan, such as replacing a service item, changing a provider, or altering plan details.

The term “normalization” refers to processing in which the processor converts input information, including modified or newly added conditions, into a standardized internal representation, such as normalized numerical ranges or category codes, suitable for prompt sentence generation and subsequent computation.

The term “selection content” refers to information representing choices made by the user based on the service provision plan, such as selected providers, selected service items, quantities, or requested execution parameters.

The term “order information” refers to data generated by the processor based on the selection content, including at least identifiers of selected providers and service items, user-related information, and execution parameters, which is formatted for transmission to an external provision service.

The term “external provision service” refers to a system or service outside the server that receives the order information and performs or arranges actual provision of services or items included in the service provision plan.

In one embodiment, a server cooperates with one or more terminals operated by a user to generate and refine a service provision plan using a generative AI model that is tightly integrated into a database querying and evaluation pipeline. The server includes a processor, a storage device, and a communication interface. The storage device stores program instructions, provider and item data, model interaction logs, and configuration parameters.

The terminals include a processor, a memory, a display device, and an input interface, and execute an application that communicates with the server over a network such as a packet-based communication network.

The server executes an operating system, such as a server-class operating system, and an application framework, such as a web application framework, to provide an application programming interface to the terminals. The server further executes a client library for accessing a generative AI model hosted either on a dedicated inference server or on an external inference service. The generative AI model is implemented as a neural network, for example a transformer-based language model comprising multiple self-attention layers, feed-forward layers, and layer normalization components. The model includes trainable parameters such as weight matrices for query, key, and value projections, as well as parameters for bias terms and normalization statistics.

The server stores service provider information and service item information in a structured data store, such as a relational database management system. The server manages tables that include fields for provider identifiers, geographic regions, categories, rating scores, historical performance metrics, and other attributes. The server further manages tables for service items that include fields for item identifiers, price values, estimated time values, category codes, ingredient or attribute flags, and availability statuses. The server defines indexes on fields such as category codes, price values, and region identifiers, and uses these indexes to accelerate search operations.

The terminal executes a user interface module that presents to the user a set of input controls for specifying preference conditions and constraint conditions. The terminal displays graphical elements that allow the user to select a type of service, choose one or more categories, input a budget, specify a time window, or exclude certain attributes. The terminal captures these inputs through its input interface and stores them in memory as a structured object. The terminal converts the structured object into a format suitable for transmission, and sends the input information to the server via the communication interface using a transport protocol.

The server receives the input information and stores it temporarily in memory. The server normalizes preference conditions and constraint conditions by converting free-form or diverse user entries into canonical internal representations. For example, the server converts natural language expressions of time into numerical ranges, converts textual category labels into category codes, and converts currency strings into numeric values. The server uses predetermined mapping tables stored in the storage device to perform such normalization.

This normalization allows the server to construct consistent prompt sentences and to generate reproducible search conditions.

The server generates a prompt sentence using the normalized input information. The server constructs the prompt sentence by concatenating template segments with inserted normalized values. For example, the server generates a text such as: “The user wants Italian cuisine, the budget is 2000 yen, and the requested delivery time is within 30 minutes. Based on this information, please propose the optimal restaurant and menu that meet these conditions.” The server may include additional instructions in the same prompt sentence to constrain the output format of the generative AI model. For example, the server may append a clause instructing the model to output a list of factors such as “price importance,” “time importance,” and “rating importance.”

The server transmits the prompt sentence to the generative AI model. When the generative AI model is deployed on a separate inference server, the server communicates with the inference server via an application programming interface. The server sends the prompt sentence and model configuration parameters such as a temperature parameter, a maximum token count, and a decoding strategy. The inference server applies the transformer-based architecture to the prompt sentence, computing contextual token representations through stacked self-attention layers and feed-forward layers. The inference server calculates probabilities over a vocabulary at each decoding step and generates a sequence of output tokens according to the specified decoding strategy.

The server receives the output tokens and reconstructs an output string as the analysis result.

The server converts the analysis result into structured information by applying deterministic parsing rules. For example, the server instructs the generative AI model in the prompt sentence to surround specific key phrases with tags, or to enumerate factors in a predictable order, and then applies regular-expression-based parsing or delimiter-based splitting to extract numeric and categorical values. The server thus obtains values such as “priority for budget,” “priority for delivery time,” and “priority for rating” as numeric weights, and may also extract revised constraints, such as a suggested narrower time window or a refined category.

The server stores the structured information in memory as a parameter object that directly defines search conditions and evaluation indices. The server then performs database search processing over the service provider information and service item information. For example, the server generates queries that filter providers by region, filter items by price range and time range, and join provider and item tables based on identifiers. The server uses the structured information to adjust the WHERE clauses and ORDER BY clauses of the database queries. For instance, when the structured information indicates that time is more important than price, the server modifies the evaluation indices so that shorter estimated time values contribute more strongly to the composite score.

The server computes evaluation scores for candidates by applying a scoring function that combines attributes with weights derived from the structured information. The server uses arithmetic operations to transform raw attributes into normalized values and to compute weighted sums or non-linear combinations. By embedding the AI-derived weights into the numeric scoring function, the server achieves a dynamic adjustment of ranking behavior without manually rewriting rules. This integrated use of AI-derived parameters and database-level evaluation operations improves the precision of the service provision plan and optimizes resource utilization by minimizing unnecessary candidate retrieval.

The server outputs the generated service provision plan to the terminal. The server packages candidate providers and items, along with their computed scores and relevant attributes, into a structured message. The terminal receives the structured message, parses it, and renders it using the display device. The terminal displays to the user a ranked list of options, each option including at least a provider name, item description, price, and estimated time value.

The user reviews the options and may initiate condition changes or plan modifications through the user interface.

The user interacts with the terminal to modify preference conditions or constraint conditions.

For example, the user may widen the time window, increase the budget, or exclude a category. The terminal captures these changes and transmits updated input information to the server. The server receives the updated input information and repeats the normalization process. The server regenerates a new prompt sentence that explicitly reflects the changed conditions. For example, the server generates a new text such as: “The user wants Italian cuisine, the budget is 2000 yen, the requested delivery time is within 45 minutes, and seafood should be excluded from the menu. Based on this, please propose the optimal restaurant and menu.” The server again invokes the generative AI model with this updated prompt sentence and receives a new analysis result.

The server converts the new analysis result into structured information, updates the search conditions and evaluation indices, and re-executes database search processing and evaluation processing. Because the server uses a consistent internal parameter object derived from the generative AI model, the iterative refinement requires only updating the parameter object and reusing the same search and scoring logic. This approach improves processing efficiency and latency, since the architecture does not require ad hoc rule updates or manual engineering efforts to handle new combinations of conditions.

The server acquires selection content from the user when the user chooses a specific provider and item from the displayed service provision plan. The server generates order information that includes identifiers of the selected provider and items, as well as user information and requested execution parameters. The server formats the order information and transmits it to an external provision service via the communication interface. The external provision service can be a logistics or fulfillment system that uses the order information to coordinate real-world actions.

The server thereby performs more than a mere abstract recommendation; the server controls the flow of data between the generative AI model, the database management system, and external services in a manner that reduces processing overhead and network utilization. For example, the server can limit database queries to a narrowed set of regions and categories identified by the structured information, which reduces the number of rows examined and the amount of data transferred. The server can further cache intermediate structured information and query plans to reuse them when similar conditions are entered by the same or other users.

This caching and reuse reduce server load and improve response time.

The server improves computer technology by introducing a non-conventional integration between AI model output and database query and evaluation mechanisms. In conventional systems, AI output often remains in free-text form and requires additional manual or heuristic processing. In contrast, the server forces the AI output into a constrained format through the design of the prompt sentence and the subsequent deterministic parsing, thereby producing structured parameters that can be directly used by the database engine. This design reduces parsing ambiguity, avoids error-prone manual interpretation, and enables the server to automatically adjust query plans and evaluation strategies.

The generative AI model itself is trained using a machine learning procedure in which weight parameters are optimized by minimizing a loss function over a corpus of training data. The model is trained to predict next tokens given previous tokens, using backpropagation to adjust weight matrices and bias terms. During training, the model processes sequences of tokens that represent user requirements, provider attributes, and expected structured outputs. An error function is computed as a difference between predicted tokens and target tokens, and gradient descent or a variant thereof is used to update model parameters. Data augmentation techniques, such as paraphrasing of instructions or variation of numeric values, may be used to improve model robustness. The server benefits from this training because the trained model can infer appropriate weights and conditions from diverse and sometimes ambiguous user inputs.

The server uses the generative AI model in a way that departs from simple human-task automation. Instead of merely replacing human decision-making about plans, the server orchestrates a sequence of computational steps in which AI-derived parameters control low-level database-specific operations. This leads to technical effects such as faster convergence to relevant plan candidates, reduced number of required database queries, and improved scoring accuracy. The server thus enhances internal data management by dynamically adjusting indices used in evaluation, and improves computational efficiency by eliminating unnecessary iterations.

In another embodiment, the server may use a different type of data store, such as a key-value store or a graph database, while maintaining the same principle of mapping structured information derived from the generative AI model to search conditions and evaluation indices. The server may also employ multiple generative AI models specialized for different service categories, and select one of the models based on the normalized preference conditions. The server can further adjust the model selection logic by storing model performance metrics and using them as factors in the scoring of candidate plans.

In yet another embodiment, the terminal may pre-process certain user inputs before sending them to the server. For example, the terminal may perform local validation or local normalization of numeric values to reduce server-side processing load. Similarly, the terminal may present explanations derived from metadata appended by the server, such as reasons why a particular option received a high score, thus enhancing the interpretability of the service provision plan without altering the server's core processing.

Through these embodiments, the server, the terminal, and the generative AI model cooperate to provide a system in which prompt sentences are used not only to obtain natural language suggestions, but to generate structured parameters that exert direct control over subsequent computational stages. This integration provides a concrete technical improvement in the generation and refinement of service provision plans, resulting in improved speed, improved accuracy, reduced resource consumption, and enhanced robustness compared to conventional systems that rely solely on static rules or unstructured AI output.

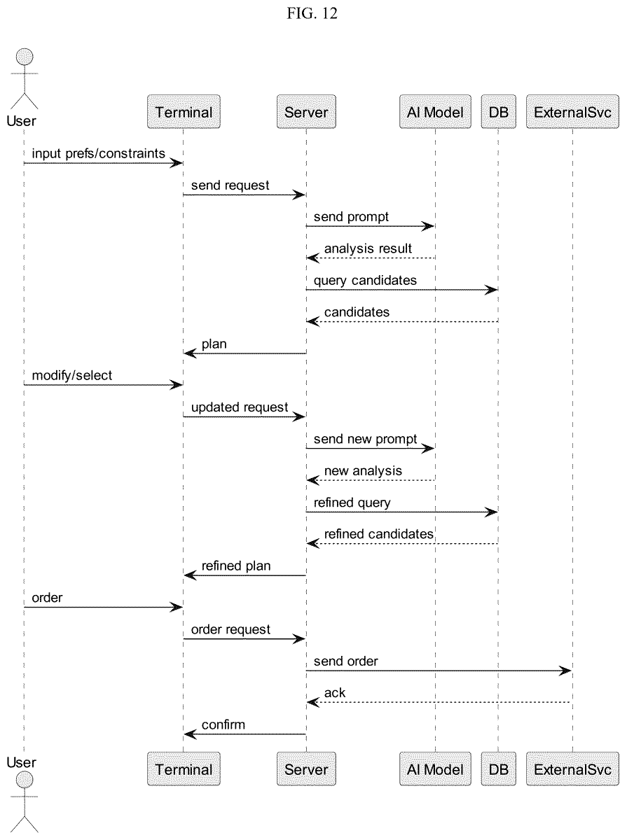

The following describes the processing flow using FIG. 12.

### Step 1:

User operates the terminal to launch an application and input initial preference conditions and constraint conditions. User enters, via graphical controls, information such as desired service category, budget, time window, and exclusion conditions. The input of this step is raw interaction events (taps, keystrokes, selections), and the output is a structured data object in the terminal memory representing the user's conditions.

### Step 2:

Terminal converts the structured data object into a transmission format and sends it to the server. Terminal serializes the object into a request message, attaches identifiers such as a user ID or session token, and transmits the message over a network connection. The input of this step is the in-memory data object produced in Step 1, and the output is a network request containing the user's conditions encoded in a machine-readable format.

### Step 3:

Server receives the network request and parses the transmitted data into server-side variables. Server validates the presence of required fields (for example, category, budget, time range), checks data types, and stores parsed values in memory. The input of this step is the raw request message from the terminal, and the output is a normalized internal representation of the user's conditions ready for further processing.

### Step 4:

Server performs normalization of preference conditions and constraint conditions. Server converts textual labels into internal codes, converts budget strings into numeric values, and transforms natural-language time expressions into numeric intervals. The server uses mapping tables and conversion rules stored in its storage device. The input of this step is the parsed but unnormalized condition set from Step 3, and the output is a normalized condition set represented as coded fields and numeric ranges.

### Step 5:

Server generates a prompt sentence for a generative AI model based on the normalized condition set. Server fills a template by inserting normalized values into predefined sentence segments. For example, server produces: “The user wants Italian cuisine, the budget is 2000 yen, and the requested delivery time is within 30 minutes. Based on this information, please propose the optimal restaurant and menu that meet these conditions.” The input of this step is the normalized condition set from Step 4, and the output is a text string that serves as the prompt sentence.

### Step 6:

Server transmits the prompt sentence to the generative AI model and obtains an analysis result. Server sends the prompt as part of a model-inference request, specifying parameters such as maximum response length and decoding options. The generative AI model applies its neural network layers to the prompt sentence and returns an output text that includes recommended weights, clarified constraints, or structured cues. The input of this step is the prompt sentence generated in Step 5, and the output is an analysis-result text string generated by the generative AI model.

### Step 7:

Server converts the analysis-result text into structured information usable for database control. Server applies parsing rules, such as splitting by delimiters or recognizing labeled segments, to extract numeric weights for attributes (for example, price importance, time importance, rating importance) and any refined constraints. The server then stores these extracted values in a parameter object in memory. The input of this step is the analysis-result text from Step 6, and the output is a structured parameter object containing search conditions and evaluation indices.

### Step 8:

Server constructs and executes database search operations based on the structured parameter object. Server translates conditions such as category codes, budget limits, time limits, and exclusion flags into queries over provider and item tables in the storage device. Server executes the queries using the database engine, which filters rows and joins tables to produce a candidate set. The input of this step is the parameter object from Step 7, and the output is a collection of candidate provider and item records retrieved from the database.

### Step 9:

Server performs evaluation processing on the candidate records to generate scores and rankings. Server computes, for each candidate, a composite score by applying arithmetic operations using the evaluation indices (for example, weighted sums of normalized price, time, and rating values). Server then sorts the candidates according to the computed scores and selects top-ranked combinations as plan elements. The input of this step is the candidate record set from Step 8 and the evaluation indices from Step 7, and the output is a ranked list of provider-item combinations forming a provisional service provision plan.

### Step 10:

Server assembles the service provision plan into a response message and sends it to the terminal. Server packs the ranked combinations, along with associated attributes and optional explanation text, into a structured response. Server transmits this response over the network. The input of this step is the ranked list from Step 9, and the output is a response message containing the generated service provision plan.

### Step 11:

Terminal receives the response message and renders the service provision plan on the display device. Terminal parses the message, maps entries to user interface components, and displays a list or other arrangement showing each provider, item, price, and time information. The input of this step is the response message from Step 10, and the output is a visual representation of the service provision plan on the terminal screen.

### Step 12:

User reviews the displayed service provision plan and optionally modifies conditions or plan details. User may adjust the budget, extend or tighten the time window, exclude specific categories or attributes, or directly modify items in the proposed plan. The input of this step is the visual information presented in Step 11, and the output is a new set of user actions that expresses condition changes or plan modifications.

### Step 13:

Terminal captures the user's condition changes or plan modifications and prepares updated input information. Terminal records new or modified values in its internal data object, marking which fields have changed. Terminal then generates an updated request message including both persistent identifiers (such as a session ID) and new condition values. The input of this step is the user actions from Step 12, and the output is an updated request message sent to the server.

### Step 14:

Server receives the updated request message and performs re-normalization of the modified conditions. Server identifies changed fields, reconverts them into internal codes and numeric ranges using the same normalization logic as before, and updates the internal representation of the user's conditions. The input of this step is the updated request message from Step 13, and the output is an updated normalized condition set reflecting the user's latest preferences and constraints.

### Step 15:

Server regenerates a new prompt sentence incorporating the updated conditions and re-invokes the generative AI model. Server constructs a revised text, such as: “The user wants Italian cuisine, the budget is 2000 yen, the requested delivery time is within 45 minutes, and seafood should be excluded from the menu. Based on this, please propose the optimal restaurant and menu.” Server sends this updated prompt to the generative AI model to obtain a new analysis result. The input of this step is the updated normalized condition set from Step 14, and the output is a new analysis-result text string from the generative AI model.

### Step 16:

Server parses the new analysis-result text into structured information and updates the parameter object. Server extracts revised weights, new exclusion criteria, or adjusted ranges from the analysis-result text, and overwrites or augments previous parameter entries. The input of this step is the new analysis-result text from Step 15, and the output is an updated structured parameter object for use in subsequent database processing.

### Step 17:

Server re-executes database search and evaluation using the updated parameter object to generate a refined service provision plan. Server applies the new search conditions, such as exclusion of particular attributes, and recalculates scores with updated evaluation indices.

The input of this step is the updated parameter object from Step 16, and the output is a refined ranked list of provider-item combinations constituting an updated service provision plan.

### Step 18:

Server transmits the refined service provision plan to the terminal, and the terminal updates the display for the user. Terminal replaces or supplements previously displayed options with the newly ranked list. The input of this step is the refined plan from Step 17, and the output is the updated visual presentation of the refined plan on the terminal.

### Step 19:

User selects a specific provider and item combination from the displayed plan to initiate an order. User confirms the choice and enters any necessary additional information, such as a delivery address or execution time. The input of this step is the refined plan display from Step 18, and the output is selection content and supplemental information entered through the terminal.

### Step 20:

Terminal sends the selection content and supplemental information to the server as an order request. Terminal constructs a message containing selected identifiers and any user-provided parameters, and transmits it to the server. The input of this step is the selection content from Step 19, and the output is an order-request message sent over the network.

### Step 21:

Server receives the order request, validates the selection, and generates order information. Server checks database records to confirm that the provider and items are still available and that constraints such as time windows are still satisfied. Server then compiles an order record including relevant identifiers, user data, and schedule parameters, and formats it for an external provision service. The input of this step is the order-request message from Step 20, and the output is order information stored internally and prepared for transmission.

### Step 22:

Server transmits the order information to an external provision service and returns confirmation data to the terminal. Server sends the order information via a communication interface to the external system and receives an acknowledgment, such as an order ID or estimated execution time. Server includes this acknowledgment in a confirmation response and sends it back to the terminal. The input of this step is the internally generated order information from Step 21 and the acknowledgment from the external service, and the output is a confirmation response message to the terminal.

### Step 23:

Terminal receives the confirmation response and displays an order confirmation screen to the user. Terminal parses the response, extracts the order ID, summarized details, and any timing information, and presents them visually. The input of this step is the confirmation response from Step 22, and the output is an on-screen confirmation that informs the user that the order based on the generated service provision plan has been accepted.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional electronic systems that support outdoor activity planning, such as hiking or climbing, typically rely on fixed templates, rule-based logic, and static databases. In many implementations, a server only stores user input and fills predefined form fields, without flexibly adapting document structure or content to the requirements of different receiving organizations or to the actual context of the user's planned activity. As a result, plan documents generated by such systems tend to be rigid, incomplete, or inconsistent with the current operational rules of destination organizations, which often require nuanced narrative descriptions and structured risk information. This leads to increased manual correction by users or operators, additional processing on the server side, and a higher risk of submission errors.

Furthermore, in existing architectures, geospatial functions such as obtaining emergency contacts, evacuation facilities, or position logs are usually implemented as separate modules independent of high-level plan generation. The server treats location acquisition and trajectory logging as mere data collection tasks and does not integrate them with the generation of plan documents. Consequently, the server cannot automatically adapt the content of the plan or related outputs based on real-time or historical location information.

This separation causes inefficiencies, such as redundant queries, fragmented data structures, and difficulty in correlating submitted plans, emergency responses, and activity histories.

In addition, many systems that attempt to incorporate machine learning or language models into document generation do so in a static manner. A prompt or template is predefined and applied uniformly to all users, regardless of the domain of the activity, the characteristics of the destination organization, or feedback from model outputs. The server therefore cannot dynamically modify prompt content in response to user inputs or previously generated results. This static prompting reduces the accuracy and reliability of generated documents and often requires the user or a human operator to manually post-edit the generated content, which undermines the advantages of automated document creation.

From the standpoint of computer technology, these issues manifest as suboptimal use of computational resources, limited adaptability of server-side logic, and poor integration of heterogeneous data processing pipelines. The server does not fully exploit the capabilities of generative models to optimize data transformations, and it handles geospatial computations, document generation, and activity logging as loosely connected processes. There is thus a need for an improved server-centric architecture and processing method that tightly couples generative AI model interaction, dynamic prompt construction, geospatial search, and time-series activity reconstruction, in order to reduce manual intervention, improve data consistency, and enhance the overall efficiency and robustness of the computing system.

Accordingly, it is an object of the present invention to improve the functioning of a computer-implemented server system by (i) integrating generative AI-based document generation with dynamic prompt control on the basis of both user inputs and model outputs, (ii) unifying geospatial search and emergency handling with plan generation in a single coordinated processing flow, and (iii) generating activity record data that algorithmically associates trajectories, emergency resources, and submission destinations for later retrieval and display. By addressing these shortcomings, the invention seeks to reduce the computational overhead of repeated manual corrections, improve the quality of generated plan information, and enable more efficient processing and retrieval of correlated plan, emergency, and trajectory data within the server environment.

The specific processing by the specific processing unit 290 of the data processing device 12 in Example 2 is realized by the following means.

The present invention provides a server comprising a processor and a storage device, the processor being configured to execute instructions that cause the server to receive abstract input information related to an activity plan from a user device, to generate a prompt sentence including the abstract input information so as to instruct a generative AI model to generate a detailed proposal of the activity plan, to input the prompt sentence into the generative AI model, to analyze a detailed proposal output from the generative AI model, and to convert the detailed proposal into structured plan information conforming to a predetermined format required by a destination organization; to automatically generate document data corresponding to a format of the destination organization based on the structured plan information and to transmit the document data to the destination organization via a communication network; to receive position information including a current position from a portable information terminal, to search an information storage unit storing geographic information and facility information based on the position information, to extract information related to emergency contacts and evacuation facilities in a vicinity of the current position, and to transmit the extracted information to the portable information terminal; to receive position information including an emergency flag from the portable information terminal, to identify candidate evacuation facilities based on the position information, and to cause at least information related to a nearest evacuation facility to be presented on the portable information terminal; and to record, in time series, position information periodically transmitted from the portable information terminal, to reconstruct an activity trajectory based on the recorded position information, to generate activity record data including the activity trajectory and at least a movement distance and a movement time, and to store the activity record data in association with at least a part of the emergency contacts, the evacuation facilities, and the destination organization, and to provide the associated activity record data for display on the portable information terminal in response to a request. This enables the server to implement a unified and technically improved processing pipeline in which dynamic prompt construction for the generative AI model, automated document generation, geospatial search, emergency handling, and time-series activity reconstruction are tightly integrated, thereby reducing manual post-editing, enhancing the accuracy and context-sensitivity of generated documents, optimizing the use of storage and computation for correlated plan and trajectory data, and improving the overall efficiency and reliability of computer-implemented outdoor activity planning and emergency support.

The term “processor” refers to a hardware or virtual computation unit, including one or more central processing units, graphics processing units, or other processing circuitry, that executes machine-readable instructions to perform the functions described in the present specification.

The term “storage device” refers to any non-transitory computer-readable medium, including semiconductor memory, magnetic storage, optical storage, or network-accessible storage, that stores data, models, configuration information, and program instructions used by the processor.

The term “user device” refers to any information processing apparatus operated by a user, including but not limited to a personal computer, a tablet device, a portable information terminal, or a communication terminal, through which the user provides input information and receives output information.

The term “portable information terminal” refers to a mobile information processing apparatus having at least a communication function and a position acquisition function, including but not limited to a smartphone, a mobile communication terminal, or a handheld computing device carried by a user.

The term “abstract input information” refers to high-level, incomplete, or unstructured data related to an activity plan that is provided by a user, such as destination, date, route name, participant information, or free-text descriptions, prior to conversion into a formalized document format.

The term “activity plan” refers to a set of planned actions or movements by a user or group of users within a certain time period and geographic area, including, for example, outdoor activities, travel schedules, or other planned operations requiring documentation and risk management.

The term “prompt sentence” refers to text data, possibly including structured elements, that is generated by the processor and provided as input to a generative AI model to instruct the model regarding the task to be performed and the manner in which output should be generated.

The term “generative AI model” refers to a machine-learned model, such as a neural network-based language model, that generates output data including text, structured data, or other content based on input data such as a prompt sentence, and that has been trained on example data to produce context-appropriate outputs.

The term “detailed proposal of the activity plan” refers to an expanded, structured, and semantically enriched representation of an activity plan generated by the generative AI model based on the abstract input information and the prompt sentence.

The term “plan information” refers to structured data derived from the detailed proposal of the activity plan, formatted according to rules or templates defined for a predetermined document schema, and suitable for automatic document generation and submission.

The term “predetermined format” refers to a predefined structural specification, layout, or data schema for representing plan information, such as fields, sections, headings, and ordering required for consistent document generation.

The term “destination organization” refers to any entity to which document data related to an activity plan is submitted, including but not limited to a public institution, an administrative body, a safety management organization, or another supervisory or coordinating organization.

The term “document data” refers to electronic data representing a document, including but not limited to structured text data, markup data, or formatted document files, that encodes plan information suitable for human or machine processing and for submission to a destination organization.

The term “communication network” refers to any wired or wireless network infrastructure, including local area networks, wide area networks, and public communication networks, through which data is transmitted between the server, the user device, the portable information terminal, and external systems.

The term “position information” refers to data representing a geographic location of the portable information terminal, including at least latitude and longitude, and optionally including altitude, accuracy, timestamp, or other parameters obtained from a position acquisition function.

The term “position acquisition function” refers to a hardware and software mechanism for determining a geographic position, including but not limited to a satellite positioning system receiver, a network-based positioning system, or a sensor-based positioning mechanism integrated in the portable information terminal.

The term “information storage unit” refers to a logical or physical data repository, implemented on the storage device, that stores geographic information, facility information, contact information, plan information, activity records, and other related data used by the processor.

The term “geographic information” refers to data describing locations, regions, or spatial relationships in a geographic coordinate system, including coordinates, map data, routes, and terrain-related information.

The term “facility information” refers to data describing facilities such as emergency service locations, shelters, or other relevant infrastructure, including but not limited to facility type, name, geographic coordinates, operating conditions, and contact details.

The term “emergency contacts” refers to contact information for entities or services that can provide assistance in an emergency, including but not limited to emergency service centers, public safety organizations, and medical institutions, together with associated communication details.

The term “evacuation facilities” refers to physical locations that can be used for temporary shelter or safety in an emergency, including but not limited to shelters, huts, bases, or designated safe areas, each associated with facility information and geographic information.

The term “emergency flag” refers to an indicator included in position information or other data transmitted from the portable information terminal that designates a state of emergency or a request for emergency-related processing by the server.

The term “candidate evacuation facilities” refers to one or more evacuation facilities identified by the processor as potentially suitable for evacuation based on position information, distance, accessibility, or other criteria.

The term “activity trajectory” refers to a representation of a path or route traveled by the portable information terminal over time, reconstructed from a plurality of position information records, and typically expressed as a sequence of coordinates ordered by time.

The term “activity record data” refers to data generated by the processor that summarizes an activity, including at least an activity trajectory, movement distance, movement time, and optionally associated facility information, contact information, and submission destination information.

The term “movement distance” refers to a computed spatial metric representing the length of a path traveled by the portable information terminal over a time period, derived from successive position information records.

The term “movement time” refers to a time-based metric representing the duration of an activity or a portion of an activity, calculated from timestamps associated with position information or other recorded events.

The term “dynamic change of contents of the prompt sentence” refers to a process in which the processor modifies, augments, or restructures the prompt sentence based on one or more factors, including the abstract input information, the detailed proposal of the activity plan, or metadata, in order to improve the relevance and quality of the generative AI model's output.

The term “target activity domain” refers to a classification or category of an activity plan, such as outdoor recreation, business travel, or logistics operations, that influences the structure and content of the plan information and the corresponding prompt sentences.

The term “associated activity record data” refers to activity record data that is stored together with related emergency contacts, evacuation facilities, and destination organizations in a correlated manner, enabling retrieval and display of linked information based on past activities.

The term “presentation on the portable information terminal” refers to the display or output of information on a user interface of the portable information terminal, including visual, audio, or other perceptible forms, enabling a user to perceive and utilize the provided information.

In one embodiment, a server, a terminal, and a user cooperate to implement the invention. The server includes at least one processor and at least one storage device. The terminal includes at least one processor, a communication interface, a position acquisition function such as a satellite positioning receiver, and a user interface display. The user operates the terminal to provide abstract input information related to an activity plan and to receive plan documents, emergency information, and activity records.

The server uses general-purpose computing hardware such as multicore central processing units and optionally graphics processing units. The server executes an operating system, such as a general-purpose server operating system, and a server-side application framework, such as a web application framework, in order to implement application programming interfaces, database control logic, and interfaces to a generative AI model. The server also uses a database management system, such as a relational database system supporting geospatial extensions, to store structured data including user accounts, raw input plans, generated plan information, geographic information, facility information, and activity logs.

The server further accesses a generative AI model. In one embodiment, the generative AI model is a large-scale neural-network-based language model implemented as a transformer architecture. The generative AI model includes an embedding layer that maps tokens to continuous vectors, a plurality of self-attention layers each having multi-head attention units, feed-forward layers, normalization layers, and an output projection layer that maps internal hidden states back to token probabilities. The server accesses the generative AI model through an application programming interface provided by a model hosting service, or alternatively executes the model on a local inference server using hardware acceleration.

The terminal is implemented as a portable information terminal such as a smartphone or a handheld computing device. The terminal executes a client application developed, for example, using a mobile application framework. The terminal uses a user interface toolkit to display screens for user input, confirmation, and emergency operations. The terminal accesses a position acquisition function using system APIs such as satellite positioning APIs or network-based positioning APIs in order to obtain latitude, longitude, and optionally altitude and accuracy values. The terminal also uses local storage such as a lightweight database for temporary buffering of user inputs and position logs.

The user operates the terminal to input abstract information related to an activity plan. The user enters, for example, a destination name, planned dates, general route names, participant names, contact numbers, and free-text notes. The terminal converts this user input into structured data elements and transmits the elements to the server using a secure communication protocol. The server stores the abstract input information in the database as a raw plan record. The use of structured database tables with defined schemas enables the server to perform consistent indexing, retrieval, and correlation of plan data with other data such as geographic information and activity logs.

The server generates a prompt sentence to be used with the generative AI model. The server composes the prompt sentence as plain text that includes both instruction segments and embedded representations of user-provided data. In one concrete example, the server generates a prompt sentence as follows:

“You are a system that creates formal activity plan documents for safety management. Convert the following activity plan into a formal plan document suitable for submission to a public safety organization. Output in a structured format with sections: 1) Overview, 2) Schedule, 3) Route, 4) Participants, 5) Equipment, 6) Emergency contacts, and 7) Emergency response plan. Activity plan data: destination=mountain area, dates=[dates provided by user], route=[route name provided by user], participants=[names and contact numbers], starting point=[location provided by user].”

In another example, the server generates a prompt sentence configured to refine or correct a previously generated plan:

“Review the following draft activity plan and correct inconsistencies in dates, times, and route descriptions. Ensure that all participant contact details are included and that the emergency response plan references appropriate local emergency contacts and evacuation facilities. Return the corrected plan in the same structured section format.”

The server dynamically adjusts the content of the prompt sentence based on multiple factors.

The server analyzes the abstract input information and the previously obtained outputs from the generative AI model. The server detects, for example, whether the plan is for a single-day activity, a multi-day activity, or a special category activity. The server also checks whether the receiving destination organization requires specific fields or a specific formal structure.

Based on these determinations, the server modifies the prompt sentence to emphasize required sections, to restrict or expand the level of detail, or to request additional clarifications from the generative AI model. This dynamic modification is not a mere substitution of template tokens, but is performed by server logic that analyzes position-dependent constraints, organization-specific rules stored in configuration tables, and statistical patterns from prior successful submissions.

The server transmits the prompt sentence and the abstract input information to the generative AI model. The generative AI model processes the prompt sentence through its internal layers.

The input text is first tokenized into subword units and mapped into embedding vectors. Each transformer layer performs multi-head self-attention, computing attention weights between tokens based on query, key, and value projections. The model calculates a contextualized representation for each token by weighted summation of value vectors. Feed-forward subnetworks apply non-linear transformations to each token representation. The output layer projects the final hidden states back into token probability distributions. The model then generates the detailed proposal of the activity plan token by token using auto-regressive decoding, conditioning each new token on previously generated tokens and the original prompt sentence.

The server receives the generated text and parses it into a structured data representation.

When the generative AI model outputs a text with explicit section headings, the server identifies these headings by pattern matching and section titles. The server then extracts field-level content into structured fields such as overview, schedule components, route segments, participant records, required equipment items, and emergency protocols. The server stores this structured plan information in a plan information table, which uses normalized relational tables to avoid redundancy and to allow efficient querying. For example, a schedule table stores rows per time segment, a route table stores rows per route segment with associated estimated times, and a participant table stores rows per participant with references to contact information.

The server converts the structured plan information into document data in a predetermined format required by a destination organization. The server uses a document generation module that reads the structured fields and populates document templates. The document generation module uses formatting libraries to create a human-readable document file. The server may apply layout rules defined per organization, such as page headers, section numbering, and fixed disclaimers. The server then transmits this document data to the destination organization over a communication network using an appropriate protocol such as secure file transfer or an application programming interface endpoint provided by the organization.

The server also manages geographic and facility data to provide emergency contacts and evacuation facilities. The server stores geographic coordinates and attributes of facilities in a geospatially indexed database. The server uses geospatial functions such as distance calculations and nearest-neighbor queries. When the terminal sends current position information, the server executes a query that selects emergency facilities within a given radius and orders them by distance or travel time. The server then transmits a subset of relevant records, including facility names, contact numbers, and brief descriptions, to the terminal.

The terminal receives the list of emergency contacts and facilities and displays them through the user interface. The user can select a facility and initiate a communication session or view additional details. The coupling of precise geospatial queries and automatically generated facility sets reduces user search time and ensures that the displayed facilities match the actual position of the terminal.

The terminal periodically acquires position information in the background. The terminal collects position samples at predetermined intervals and stores them locally with timestamps.

To reduce communication overhead, the terminal aggregates these records into batches and transmits them to the server at appropriate times. The server writes the received position samples into a time-series table linked to a specific activity plan. The server reconstructs an activity trajectory by ordering the samples by time and computing intermediate estimates when necessary. The server derives movement distance using geodesic distance formulas on the sequence of coordinates and computes movement time from the earliest and latest timestamps. The server stores this activity record data, including trajectory and movement statistics, in association with the plan, emergency contacts used, and evacuation facilities referenced during the activity.

The server supplies these activity record data to the terminal upon request. The terminal displays trajectories over map imagery and shows associated events such as when the user accessed emergency information or when the terminal transmitted an emergency flag. This integrated representation allows the user to review past activities and safety-related events.

The server uses specific data structures and processing steps to achieve technical improvements. The use of normalized relational tables with foreign-key relationships enables the server to avoid duplicate storage of repeated plan elements and to quickly retrieve and recombine data into new plan documents. The server uses geospatial indexes to accelerate distance calculations, reducing latencies of emergency queries. The server also maintains precomputed caches of typical prompt fragments and organization-specific instruction templates, enabling prompt generation to be performed with reduced computation compared to constructing full prompts from scratch for each request.

The generative AI model itself is trained using supervised learning and, optionally, reinforcement learning based on human feedback. In supervised learning, the model is trained on pairs of input prompts and target plan documents. The model minimizes a sequence-level loss function such as cross-entropy between the predicted token distribution and the target token distribution. Weight updates occur through gradient descent-based methods, such as adaptive optimization algorithms. During training, data augmentation can be performed by varying the order of sections, modifying wording, and introducing realistic noise into user inputs, which improves robustness to diverse input forms. In some cases, the model undergoes fine-tuning on domain-specific plan documents associated with outdoor activities, improving the accuracy and coherence of the generated detailed proposals.

The server leverages the structure of the generative AI model to obtain technical benefits beyond simple human task automation. For example, the server intentionally constrains maximum output length, layer activation ranges, and decoding temperature to reduce variability and latency. The server employs beam search or top-k sampling with cut-off heuristics to compute candidate token sequences efficiently, thus reducing inference time compared to naive sampling while preserving sufficient diversity for meaningful content.

These techniques directly affect processing speed and computational resource utilization in the server.

The server uses rule-based post-processing combined with the generative AI model to enforce non-human-centric constraints. For instance, the server applies consistency-checking algorithms that verify alignment between scheduled times and activity durations derived from route lengths and typical speeds. When inconsistencies are found, the server either modifies the prompt sentence to request correction by the generative AI model or applies deterministic corrections using stored domain rules. This hybrid approach improves the internal consistency of documents while reducing repeated calls to the model and minimizing unnecessary computation.

The server further implements dynamic prompt generation that differs from manual human drafting. Rather than simply inserting values into a static template, the server computes a prompt structure based on classification of the incoming activity plan. This classification uses decision logic evaluating factors such as duration, season, elevation, and historical incident data in the database. The server may select different instruction sets for high-risk versus low-risk activities. Because the prompt structure is adaptively tailored to relevant conditions, the generative AI model tends to focus on pertinent risk factors, improving the precision and completeness of the resulting plan information. This dynamic tailoring also reduces the average number of correction cycles, thereby improving throughput.

In one concrete example, the user plans a multi-day mountain activity. The terminal collects the following abstract input: destination name, two-day date range, a general trail name, participant list, and a comment that one participant has low experience. The server detects, through simple rule-based evaluation, that the plan is multi-day and includes low-experience participants. The server then chooses a prompt sentence variant that emphasizes risk management sections and requires additional detail for overnight stays:

“You are a system that creates formal multi-day mountain activity plan documents for safety management. The participants include members with limited experience, so you must include more detailed risk mitigation and contingency plans. Generate sections: Overview, Day-by-day schedule, Route details, Participant experience levels, Equipment checklist, Emergency communication plan, Evacuation routes, and Alternate plans for bad weather.”

By automatically selecting this enhanced prompt structure, the server achieves more complete coverage of risk-related content than a standard template would, without requiring the user to manually specify all details. Since the dynamic selection is executed by the server on every request, the system produces more reliable plans at scale with lower manual oversight.

In another example, the user directly or indirectly provides a prompt such as:

“Tell me the emergency contacts and evacuation locations when planning a mountain activity in a given region. Also, automatically generate an activity plan document and prepare it for submission to a public safety organization.”

The server interprets this as a request for both plan generation and emergency data. The server subdivides the request into a plan-generation part and an emergency-information part.

The server uses the generative AI model only for narrative and structural generation while applying deterministic geographic queries for facility retrieval. By separating narrative generation from geospatial computation, the server avoids sending raw geographic tables to the generative AI model, thereby preserving computational and network resources and limiting the complexity of the model queries.

The system yields technical effects. The dynamic prompt generation and hybrid rule/model pipeline reduce the number of generative passes needed to obtain a consistent plan. This directly lowers processing latency and server-side computational load. The normalized database design and geospatial indexing improve query performance when retrieving emergency contacts and evacuation facilities, resulting in faster responses when the terminal sends an emergency flag. The batched transmission of position logs from the terminal reduces network overhead while maintaining adequate resolution for trajectory reconstruction. The correlation of activity trajectories with emergency contacts and destination organizations in the database improves retrieval operations when reconstructing and analyzing past activities, reducing search complexity and enabling efficient generation of activity summaries.

The invention is not limited to one specific hardware or software stack. The server may run on a local data center or a cloud infrastructure. The generative AI model may be provided by a remote service or executed on an on-premise inference cluster. The database may be a relational database with geospatial extensions or any storage layer providing equivalent geospatial search functions. The terminal may be a smartphone, a tablet, or a specialized outdoor device with similar position acquisition and communication functions.

In a variant embodiment, the server employs a smaller, locally hosted generative AI model for low-latency or offline environments. The model may be a transformer with fewer layers and lower parameter count, fine-tuned specifically on activity plan data. In another variant, the server uses multiple generative AI models: one model for long-form document generation and another model optimized for short corrections and validations, with the server routing requests between them based on the detected complexity of the task. In yet another variation, the server maintains precomputed vector representations of typical activity plans and uses vector similarity search to select prompt examples that are embedded into the prompt sentence as in-context references, improving the coherence of generated plans without increasing training complexity.

Through these embodiments, the server, terminal, and user cooperate in a way that tightly couples generative AI processing with geospatial search, structured data management, and time-series activity logging. The described architecture and algorithms provide a specific improvement in computer technology by optimizing inference workflows, reducing communication and storage overhead, increasing the internal consistency and contextual relevance of generated plan documents, and enabling efficient retrieval and analysis of correlated planning, emergency, and trajectory data.

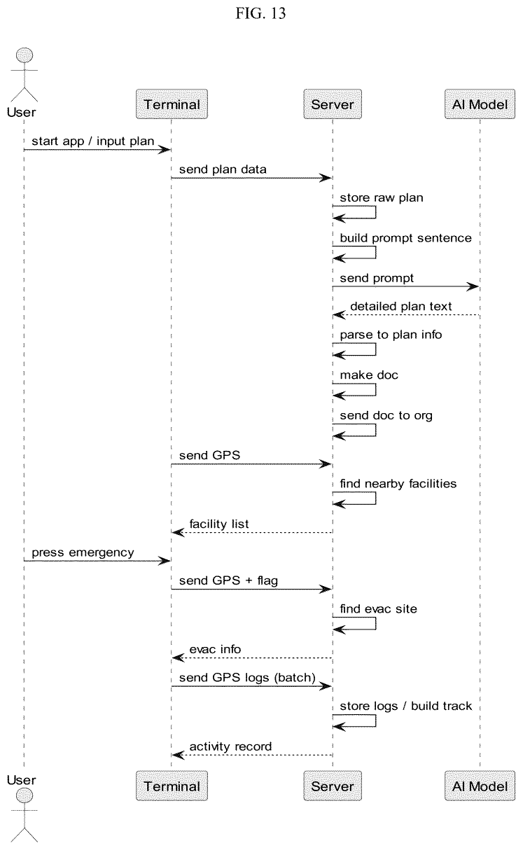

The following describes the processing flow using FIG. 13.

### Step 1:

The user operates the terminal to start an application and select creation of a new activity plan.

The terminal displays input fields for destination, dates, general route name, participants, and free-text notes.

Input: raw keystrokes and touch events from the user.

The terminal converts these events into structured input data objects (for example, strings for names, date objects for schedule, numerical identifiers for route options) and performs local validation such as required-field checks and date-range checks.

Output: validated abstract input information representing an activity plan, stored in the terminal's memory.

### Step 2:

The terminal transmits the validated abstract input information to the server over a communication network.

Input: structured abstract input information and a user identifier or authentication token.

The terminal serializes the information into a message format, attaches the authentication token, and sends the message using a secure communication protocol.

Output: a network request containing the abstract input information that arrives at the server.

### Step 3:

The server receives the abstract input information and stores it as a raw plan record in a database.

Input: serialized abstract input information and user identifier from the terminal.

The server deserializes the message, checks the authentication token, maps the data fields into database columns, and inserts a new row into a raw-plan table with fields such as destination, dates, route label, and participants.

Output: a persistent raw plan record with a unique plan identifier stored in the database.

### Step 4:

The server generates a prompt sentence for a generative AI model based on the raw plan record.

Input: raw plan record retrieved from the database, and configuration rules for prompt construction.

The server reads the plan fields, selects an appropriate prompt template according to plan type and destination organization rules, and concatenates instruction text with embedded plan values to form a natural-language prompt sentence.

For example, the server generates a prompt sentence such as:

“You are a system that creates formal activity plan documents for safety management.

Convert the following activity plan into a formal plan document suitable for submission to a public safety organization. Output in a structured format with sections: 1) Overview, 2) Schedule, 3) Route, 4) Participants, 5) Equipment, 6) Emergency contacts, and 7) Emergency response plan. Activity plan data: destination=[destination from user], dates=[dates from user], route=[route name from user], participants=[names and contact numbers], starting point=[user-specified starting point].”

The server may adjust sections or wording based on risk level or organization type.

Output: a complete prompt sentence text ready to be sent to the generative AI model.

### Step 5:

The server transmits the prompt sentence and plan context to the generative AI model and receives a detailed proposal of the activity plan.

Input: prompt sentence, plan identifier, and model parameters such as maximum output length and decoding options.

The server formats an API request containing the prompt sentence and parameters, sends it to the generative AI model endpoint, and waits for a response. The generative AI model processes the prompt internally using embedding, attention, and decoding computations to generate a text description of a detailed proposal.

Output: a generated detailed proposal text, received by the server as a response string or structured text.

### Step 6:

The server converts the detailed proposal text into structured plan information.

Input: detailed proposal text from the generative AI model.

The server parses the text by detecting section headings and delimiters, splits the text into sections such as overview, schedule, route, participants, and emergency plan, and then extracts key fields using pattern matching or rule-based parsers. The server builds structured records for schedules, route segments, participant entries, and equipment lists.

Output: structured plan information stored in memory as data structures and also written into a plan-information table in the database linked with the raw plan record.

### Step 7:

The server generates formal document data based on the structured plan information and transmits it to a destination organization.

Input: structured plan information and document-format specifications for a particular destination organization.

The server loads formatting rules, maps plan fields into a document template, and calls a document formatting engine to create document data such as a formatted text document or document file. The server then establishes a connection to the destination organization interface, attaches the document data, and transmits it using a designated protocol.

Output: a submitted plan document at the destination organization and a submission status entry stored in the server database.

### Step 8:

The terminal acquires current position information and sends it to the server.

Input: signals from satellite positioning hardware or network-based positioning systems, and time information.

The terminal calls system-level position APIs to obtain latitude, longitude, and optional altitude and accuracy, packs these values with a timestamp into a position information object, and transmits the object to the server using a network request.

Output: a current position message that reaches the server.

### Step 9:

The server retrieves emergency contacts and evacuation facilities near the current position.

Input: current position information from the terminal.

The server converts the latitude and longitude into a geospatial query, searches geographic and facility tables using distance calculations, filters facilities within a defined radius, and sorts them by distance or priority.

Output: a list of emergency contacts and evacuation facility records, including names, coordinates, contact numbers, and attributes, prepared for transmission to the terminal.

### Step 10:

The server sends the list of emergency contacts and evacuation facilities to the terminal, and the terminal displays them to the user.

Input: list of facility records prepared by the server.

The server serializes the list into a response message and sends it back to the terminal. The terminal receives the message, parses the records, and renders them on the user interface as a list and, optionally, as markers on a map.

Output: a visible list and map of nearby emergency contacts and evacuation facilities on the terminal display.

### Step 11:

The user initiates an emergency operation on the terminal.

Input: user interaction, such as pressing an emergency button on the terminal screen.

The terminal captures this input event, triggers an emergency mode flag in its internal state, and immediately re-acquires current position information through the position acquisition function. The terminal then composes an emergency message including position coordinates, timestamp, user identifier, and an emergency flag.

Output: an emergency request message with embedded position information transmitted to the server.

### Step 12:

The server processes the emergency request and identifies candidate evacuation facilities.

Input: emergency request message from the terminal containing current position and emergency flag.

The server logs the emergency event in an emergency-event table, then runs a geospatial search similar to normal facility queries but with emergency-specific filters such as maximum safe distance or preferred facility types. The server calculates distances from the current position to candidate facilities and determines the nearest or most suitable evacuation facility according to configured criteria.

Output: a selected subset of evacuation facility information, including at least one nearest evacuation facility, prepared for transmission to the terminal.

### Step 13:

The server sends evacuation facility information to the terminal, and the terminal presents the information to the user.

Input: selected evacuation facility records from the server.

The server serializes the records into a response message and transmits them to the terminal.

The terminal receives the message, parses the facility data, and displays an emergency screen showing the nearest evacuation facility along with direction or a simplified route overlay on a map.

Output: a visual emergency guidance display on the terminal indicating destination and basic route information.

### Step 14:

The terminal periodically collects position logs and transmits them to the server in batches.

Input: periodic readings from the position acquisition function along with timestamps.

The terminal runs a background process that, at configured intervals, queries the position APIs, stores each reading with a timestamp in a local log buffer, and, when a batch size or time threshold is reached, groups multiple readings into a batch object and sends the batch to the server.

Output: a batched position log message delivered to the server containing a sequence of timestamped coordinates.

### Step 15:

The server records the received position logs and reconstructs an activity trajectory.

Input: batched position log message from the terminal.

The server deserializes the batch, inserts each position sample into a time-series location log table associated with a specific activity plan and user, and then retrieves ordered samples when trajectory analysis is needed. The server sorts the samples by timestamp, forms a continuous path representation by linking adjacent coordinates, and computes movement distance using geographic distance formulas applied to successive coordinate pairs. The server computes movement time as the difference between the earliest and latest timestamps in the relevant log.

Output: an activity trajectory representation and movement metrics stored as activity record data in the database.

### Step 16:

The server associates activity record data with emergency and submission information and provides it to the terminal upon request.

Input: activity trajectory, movement metrics, emergency event records, facility usage records, and submission records linked to the same plan.

The server joins these records using plan identifiers and user identifiers to build a composite view of the activity, including when and where emergencies were triggered, which facilities were suggested, and which destination organizations received documents. The server formats this composite data into an activity summary structure and transmits it to the terminal when the user requests to view past activities.

Output: a consolidated activity record, including trajectory and related safety and submission information, displayed by the terminal to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional planning and safety-support systems for outdoor activities and facility navigation mainly use servers as simple data stores and rule-based engines. In such systems, a processor typically receives static input data, applies predetermined templates or fixed rules, and outputs a plan or a set of alerts. This architecture suffers from several technical problems.

First, the processor is not configured to dynamically construct machine-interpretable prompt sentences for a generative AI model based on heterogeneous user state information, including emotion-related data and real-time position data. As a result, the server cannot flexibly generate or adapt complex action plans or narrative records in response to changing conditions, and the computational workflow remains rigid and inefficient.

Second, existing systems treat location tracking and emergency notification as separate, loosely coupled functions. They generally log position samples but do not systematically correlate time-ordered position information with emotion-related data and generated plans inside a unified data structure. This prevents the processor from executing integrated data processing operations, such as route reconstruction, dwell-time analysis, and automatic determination of emergency-notification necessity based on combined spatial and emotional patterns. Consequently, server-side decision logic remains shallow and cannot leverage modern machine learning pipelines effectively.

Third, conventional server architectures do not provide a generalized mechanism for automatically generating higher-level narrative content from raw logs using a generative AI model. Although some systems may store GPS traces or textual comments, they do not synthesize these heterogeneous datasets into behavior record data, construct story-generation prompt sentences, and consume generative AI outputs as structured, machine-managed narrative content linked back to underlying sensor and plan data. This limits the system's ability to generate rich summaries or analytic artifacts and forces downstream applications to rely on manual or ad hoc processing.

Fourth, many indoor analytics systems that use wireless identifiers or beacons are hard-coded for a particular use case, such as retail analytics, and do not integrate their movement-path estimation and dwell-time analysis with the same core server architecture that manages outdoor safety, emotion monitoring, and generative AI integration. As a result, there is no unified computational framework where the same processor can interpret identification information from wireless transmitters, estimate movement paths, compute dwell times, and generate optimization information for facility operation or service provision using the same data and model orchestration layer that is used for outdoor action planning and storytelling.

Accordingly, there is a need for an improved computer-implemented system in which a processor coordinates: (i) generation of prompt sentences for a generative AI model; (ii) integration of real-time state information including position information data and emotion-related data; (iii) automatic generation and submission of plan documents to emergency response organizations; (iv) construction of behavior record data that unifies routes, dwell times, and emotions; (v) story-generation workflows using generative AI outputs as first-class data objects; and (vi) indoor movement-path and dwell-time analysis from wireless identification transmitters. Such a system should improve the operation of the processor and memory by defining specific data structures and processing sequences that enable richer, more accurate, and more automated server-side computation, rather than merely automating human tasks.

The specific processing by the specific processing unit 290 of the data processing device 12 in Application Example 2 is realized by the following means.

The present invention provides a server comprising a processor configured to acquire input information from a user, generate a first prompt sentence including the input information, and send the first prompt sentence to a generative AI model to cause the generative AI model to generate an action plan; receive, from the generative AI model, the action plan as machine-readable text data, automatically generate plan document data in a predetermined format based on the action plan, and electronically transmit the plan document data to an emergency response organization via a communication interface; periodically acquire, from an information processing terminal of the user, state information including position information data and emotion-related data, determine necessity of an emergency notification based on the action plan and the state information, and, when the emotion-related data satisfies a predetermined condition, generate automatic notification data including at least current position information and transmit the automatic notification data to the emergency response organization; store the position information data in time order in a storage device, generate movement route information and stay time information based on the stored position information data, and generate behavior record data in which the movement route information, the emotion-related data, and the action plan are associated with one another in a unified data structure; generate a second prompt sentence for story generation including summary description information of the behavior record data and the emotion-related data, transmit the second prompt sentence to the generative AI model to cause the generative AI model to generate content in a narrative format, and store the content in the narrative format in association with the behavior record data; provide, through the communication interface, record display data including at least the movement route information and the content in the narrative format to the information processing terminal of the user; based on the position information data, acquire contact information and position information of emergency response bases from a plurality of base-information storage units corresponding to a predetermined area, provide the contact information and the position information to the information processing terminal of the user, and generate control information that enables the information processing terminal of the user to execute a notification operation by a single user operation; and estimate a movement path of the user based on identification information acquired from at least one wireless identification transmitter installed in an indoor space and the position information data, analyze stay time in each area to generate movement-path analysis result data, and output information for optimization of facility operation or service provision using the movement-path analysis result data. This enables the server to implement an integrated, computer-centric workflow in which the processor orchestrates prompt-sentence generation, generative AI calls, time-ordered storage and correlation of sensor and emotion data, automatic emergency notification decisions, narrative-content generation, and indoor movement-path analytics, thereby improving the functioning of the computer system itself by defining specific data structures, processing sequences, and model interactions that yield more accurate, context-aware, and automated computational outcomes than conventional rule-based or template-only systems.

The term “processor” refers to a hardware or virtual processing unit, such as a central processing unit or a processing core, configured to execute computer-readable instructions to perform the functions described in this specification.

The term “user” refers to a person or an entity that provides input information, carries an information processing terminal, and receives output information generated by the system.

The term “input information” refers to data provided by the user, including at least information indicating an intended activity, such as a destination, schedule, difficulty level, or other parameters used to generate an action plan.

The term “prompt sentence” refers to text data constructed in natural or formal language that is supplied to a generative AI model in order to specify a task and constrain generation of an output, such as an action plan or a narrative.

The term “generative AI model” refers to a software-implemented machine learning model, such as a natural language generation model, that receives a prompt sentence and outputs generated content including text or other machine-readable data.

The term “action plan” refers to structured plan information generated by the generative AI model based on the prompt sentence, including at least a sequence of actions, schedule information, or route information relating to an activity of the user.

The term “plan document data” refers to electronic document data automatically generated based on the action plan, formatted in accordance with a predetermined layout suitable for submission to an external organization.

The term “emergency response organization” refers to a public or private organization that performs emergency support, such as a rescue organization, a medical organization, or a security organization, and that can receive plan document data or notification data from the server.

The term “information processing terminal” refers to an electronic device operated by the user, such as a portable terminal or a stationary terminal, having at least a communication function, a user interface, and optionally a position detection function and sensor interfaces.

The term “state information” refers to information indicating a current state of the user or the information processing terminal, including at least position information data and emotion-related data acquired at one or more points in time.

The term “position information data” refers to data indicating a geographical or spatial position of the information processing terminal or the user, such as coordinates, altitude, or zone information, acquired by a position detection mechanism.

The term “emotion-related data” refers to data representing an estimated or declared emotional state of the user, obtained from sensors, analysis of user input, or external emotion analysis services, and including at least a type of emotion and optionally an intensity or confidence value.

The term “emergency notification” refers to an alert or information transmission from the server or the information processing terminal to an emergency response organization, indicating that the user may require urgent support.

The term “automatic notification data” refers to data generated by the processor for transmission to an emergency response organization without manual composition by the user, the data including at least identification information and current position information.

The term “movement route information” refers to information derived from time-ordered position information data, representing at least a path or sequence of positions that the user has moved along over a period of time.

The term “stay time information” refers to information indicating, for each of one or more areas or segments, a duration for which the user remained within a defined region or at a defined position, computed from time-ordered position information data.

The term “behavior record data” refers to data in which movement route information, stay time information, emotion-related data, and the action plan are associated in a unified data structure so that temporal and spatial relationships between user behavior and emotions can be analyzed.

The term “summary description information” refers to condensed information derived from behavior record data, such as key events, time segments, or highlights, used for constructing a story-generation prompt sentence.

The term “content in a narrative format” refers to generated data, typically text, representing a story or narrative that describes at least part of the user's activity or experience, produced by the generative AI model in response to a story-generation prompt sentence.

The term “record display data” refers to data prepared by the processor for presentation on the information processing terminal, including at least movement route information and content in a narrative format, and optionally additional analytical or visualization information.

The term “base-information storage unit” refers to a storage resource, such as a database or memory structure, that stores contact information and position information of emergency response bases or similar facilities for a predetermined area.

The term “emergency response base” refers to a facility or location operated by an emergency response organization, such as a rescue base, medical facility, or security station, that can receive contact from the user or the server.

The term “control information” refers to data provided to the information processing terminal that configures the terminal to execute a notification operation, such as initiating a call or message, responsive to a single user operation.

The term “wireless identification transmitter” refers to a device installed in an environment, such as an indoor space, that periodically or on demand transmits identification information using a wireless communication scheme to enable position or zone estimation.

The term “identification information” refers to data transmitted from a wireless identification transmitter, uniquely or semi-uniquely identifying the transmitter or its associated area.

The term “movement path” refers to a representation of a trajectory of the user within at least part of a space, estimated based on identification information from wireless identification transmitters and position information data.

The term “movement-path analysis result data” refers to data derived from analysis of a movement path and stay time in different areas, including metrics or indicators that characterize how the user or multiple users moved through a facility.

The term “facility operation or service provision optimization information” refers to information generated by the processor from movement-path analysis result data, indicating improvements, adjustments, or evaluations for operating a facility or providing a service more efficiently or effectively.

In one embodiment, a server implements the claimed system as a network-accessible computation platform. The server comprises at least one processor, a main memory, a nonvolatile storage device, and a network interface. The processor executes program modules stored in the memory and configured to perform prompt-sentence generation, generative AI model interaction, state-information integration, emergency-notification determination, behavior-record construction, story generation, and movement-path analysis. An information processing terminal operated by a user is implemented as a portable device, such as a smartphone or tablet, including a processor, a display, input interfaces, a positioning module (for example, a GPS receiver), a wireless communication module, and optionally sensor interfaces for camera and microphone.

The server executes an application module implemented, for example, using a server-side execution environment such as a general-purpose programming language runtime. The server stores structured data in a database management system, such as a relational database or a document-oriented database. The terminal executes an application module implemented, for example, using a mobile operating system framework, and communicates with the server over a packet-switched network using a secure protocol.

In one embodiment, the server acquires input information from the user through the terminal.

The user operates the terminal to input information such as an intended destination, a planned date, a desired difficulty level, an activity type, and optional participant details. The terminal structures this input information in a predetermined schema, associates it with a user identifier, and transmits it to the server via the network interface.

The server stores the received input information as typed fields within a plan-input data structure in the database. The server then generates a first prompt sentence for a generative AI model. The server constructs the prompt sentence by mapping each field of the plan-input data structure to a language template. For example, the server generates a prompt sentence such as:

“The user wants to climb Mt. Fuji as an intermediate day trip. Generate a safe, detailed mountaineering plan including route, schedule, required equipment, and safety precautions.”

The server implements this mapping as a deterministic text-assembly algorithm that concatenates and normalizes fields while enforcing syntax constraints, thereby producing a prompt sentence that is optimized for consumption by a generative AI model.

In one embodiment, the generative AI model is implemented as a neural network-based language model deployed on a separate computation service. The generative AI model uses a transformer architecture including multiple self-attention layers, feedforward layers, and embedding layers. The model is trained using a corpus of text that includes route descriptions, safety guidelines, and temporal planning examples. During training, the model minimizes a cross-entropy loss function between predicted tokens and target tokens, and updates weights using a gradient-based optimization algorithm. The model processes the prompt sentence as a sequence of tokens, computes contextual representations via multi-head self-attention, and outputs a probability distribution over tokens at each generation step.

The server transmits the first prompt sentence to the generative AI model via an application programming interface. The server receives the output as text that constitutes an action plan.

The action plan includes, for example, specified departure time, recommended route segments, intermediate checkpoints, estimated arrival times, recommended equipment items, and warnings. The server parses the generated text and stores it as an action-plan data structure with typed fields and references to the original input information. The server uses rule-based parsing and pattern matching to separate temporal expressions, location expressions, and instruction phrases, improving downstream processing efficiency.

In one embodiment, the server generates plan document data based on the action-plan data structure. The server executes a document-layout module that populates a predetermined document template with fields from the action-plan data structure and the user information.

The server generates a document object, for example, a formatted document describing the route, schedule, participant list, and emergency contact section. The server stores the plan document data in a document store and transmits the document data, or a representation thereof, to an emergency response organization using an electronic communication channel.

Because the server stores the action-plan data structure and the plan document data in linked form, the server can later regenerate or update the document without re-requesting a full plan from the generative AI model, thus reducing external model calls and communication overhead.

In one embodiment, the terminal periodically acquires state information including position information data and emotion-related data. The terminal uses a positioning module (for example, a satellite-based positioning subsystem or a network-based location subsystem) to acquire latitude, longitude, altitude, and timestamps. The terminal stores the position information in a local buffer and transmits batched records to the server. The terminal optionally acquires emotion-related data by capturing short sensor sequences from a camera or microphone, or by accepting user-entered emotion labels. The terminal either transmits the sensor data to the server or processes the sensor data locally using an emotion-recognition module that outputs emotion labels and intensity scores.

The server stores the position information data in time order within a time-series data store.

The server also stores the emotion-related data as entries with timestamps and references to the corresponding time intervals. The server thereby constructs state-information streams that can be indexed by time and by user identifier. The server uses specialized indexes for time-series data, which reduce query time for range queries and improve performance when reconstructing routes and emotion timelines, thereby improving computation speed and memory access patterns relative to generic table scans.

The server determines whether an emergency notification is necessary by evaluating a predefined decision function over the action plan and the state information. For example, the server compares the current time and position information against the expected schedule and route from the action-plan data structure to detect deviations or delays. The server also evaluates emotion-related data by applying threshold conditions to emotion intensity scores or aggregating recent values with an exponential moving average. When one or more conditions are satisfied, such as sustained panic, fear, or prolonged deviation from the planned route, the server generates automatic notification data that include at least an identifier of the user, current position information, and a reference to the corresponding plan document. The server transmits this automatic notification data to an emergency response organization, thereby enabling earlier and more accurate detection of problematic situations than manual reporting.

In one embodiment, the server generates movement route information and stay time information based on the stored position information data. The server computes movement route information by connecting consecutive position samples in time order and optionally interpolating missing positions using linear interpolation. The server groups positions into segments by time, altitude, or map region. The server computes stay time information by detecting intervals during which the user remains within a defined spatial radius, and calculating time differences between first and last samples in each region. The server stores movement route information and stay time information in a route-record data structure.

The server generates behavior record data by associating the route-record data structure, the emotion-related data, and the action-plan data structure. The server uses a unified schema that allows each time-aligned entry to store position, emotion label, emotion intensity, and planned vs. actual schedule deviation. By storing these fields together, the server can perform join-free queries to compute, for example, emotion distribution by altitude or deviation distribution by time segment, improving computation efficiency and reducing the number of disk accesses relative to systems that maintain separate, loosely coupled logs.

In another embodiment, the server generates a second prompt sentence intended for story generation. The server produces summary description information from the behavior record data by applying a segmentation algorithm. The server identifies key events such as start, arrival at intermediate checkpoints, summit, and descent completion based on time and altitude patterns. The server then identifies emotion peaks or sudden changes in emotion intensity from the emotion-related data. The server uses these summaries to compose a second prompt sentence, for example:

“The user climbed Mt. Fuji as an intermediate day trip. The route started at 06:00 from the fifth station, reached the summit at 11:00, and finished at 15:00. GPS data shows a steep and slow section between 08:00 and 09:00, where the user felt anxiety, and strong joy at the summit. Using this information, generate a narrative story of the hike that emphasizes the feeling of accomplishment at the summit.”

The server transmits the second prompt sentence to the generative AI model. The generative AI model, using the same or a different transformer-based architecture, generates content in a narrative format describing the user's experience. The server stores this narrative content in association with the behavior record data. Because the server uses a structured behavior record as an input to the prompt construction process, the narrative content is aligned with precise route and emotion data, allowing later retrieval and visualization at fine temporal granularity.

In one embodiment, the server provides record display data to the terminal. The record display data includes at least movement route information and the content in a narrative format, and may additionally include metrics such as total time, elevation gain, and section durations. The terminal renders the route on a map component and presents the narrative content as text, allowing the user to visually correlate specific map segments with narrative sections. By providing the display data in a pre-aggregated form, the server reduces computation load on the terminal and limits network bandwidth usage by transmitting only selected summaries instead of raw, high-frequency logs.

In another embodiment, the server acquires contact information and position information of emergency response bases from multiple base-information storage units. The server stores base information as records comprising an identifier, geographic coordinates, contact numbers, and service types. The server uses spatial indexing to efficiently obtain nearest bases for a given user position. The server then provides the contact information and position information to the terminal and generates control information that enables a single operation, such as a single tap, to initiate a call or message to a selected base. The terminal uses this control information to configure user interface elements and operating system-level call or messaging interfaces. This architecture reduces cognitive and operational load on the user during emergencies and ensures that the server controls and optimizes the selection of emergency contacts based on current position.

In a further embodiment, the server estimates a movement path in an indoor space. The terminal acquires identification information from one or more wireless identification transmitters installed in a facility, such as beacons or other short-range transmitters. The terminal transmits sequences of identification information and timestamps to the server. The server correlates the identification information to spatial zones defined in a facility map. By combining identification sequences and any available position information data, the server reconstructs an approximate movement path through the facility. The server then analyzes stay time in each zone to generate movement-path analysis result data, including metrics such as dwell time per zone, frequency of transitions between zones, and peak occupancy times.

The server outputs information for optimization of facility operation or service provision based on the movement-path analysis result data. For example, the server may output heatmaps or authorization for dynamic reallocation of resources. Because the server uses the same unified data processing platform for both outdoor activity planning and indoor movement analysis, the server can reuse analytical modules and maintain consistent data structures, resulting in improved maintainability and processing efficiency.

In one embodiment, the generative AI model is trained or fine-tuned using domain-specific data. The training data includes annotated examples of action plans, safety-related instructions, and narrative descriptions of activities. The model is trained using a supervised learning procedure, where the error function is the sum of token-level cross-entropy losses over all positions. The weight update is performed using a variant of stochastic gradient descent with adaptive learning rate. The model applies dropout and layer normalization to improve generalization. During inference, the server constrains generation using techniques such as nucleus sampling or beam search with domain-specific decoding rules. For example, the server can enforce that the generated action plan includes at least one emergency contact section and a time-ordered schedule.

This technical design produces several advantages in computer operation. First, by defining specific data structures (plan-input data structure, action-plan data structure, behavior record data, movement-path analysis result data) and specific prompt-sentence constructions tied to those structures, the server reduces the number and size of interactions with the generative AI model. The server uses structured parsing and caching of generated outputs so that later operations (such as reformatting a plan or updating a narrative after receiving additional position data) can be executed without re-running the full generative process. This improves processing speed and reduces external computation and communication cost.

Second, by correlating position information data, emotion-related data, and action-plan data in a unified behavior record, the server can execute complex analytical queries and emergency-notification decisions using efficient index structures, instead of performing repeated ad hoc joins or scanning of separate logs. This design improves accuracy of deviation detection, since the server can compare actual positions against planned checkpoints and also incorporate emotion patterns into the decision logic. As a result, the technical system achieves lower false positives and false negatives in emergency detection than systems that only check time or position deviations.

Third, by using identification information from wireless identification transmitters and combining it with position information data, the server can estimate a movement path indoors where conventional satellite-based positioning is inaccurate or unavailable. The server's path-estimation algorithm uses non-conventional logic that fuses discrete identification events with any available continuous position data and a facility topology model. This approach yields improved spatial resolution and dwell-time accuracy relative to relying on either source alone, and directly optimizes the internal representation of user movement used for facility operation decisions.

Fourth, the use of a transformer-based generative AI model is not limited to automating a human mental process; the server orchestrates this model in a structured pipeline where the generative outputs are parsed, normalized, cached, and reused in multiple downstream computations. The server imposes domain-specific constraints on generation, applies deterministic post-processing, and integrates the outputs into data structures that are then used for route reconstruction, emergency decision logic, and analytical reporting. These operations improve the internal functioning of the computer system as a whole by reducing redundant computation, improving memory locality, and enabling faster query responses.

Alternate embodiments are possible. In one embodiment, the server executes the generative AI model locally on a specialized hardware accelerator, such as a graphics processing unit or a tensor processing unit, instead of calling an external service. In another embodiment, the emotion-related data are derived purely from user-entered text logs and analyzed by a separate neural network trained for sentiment classification. In yet another embodiment, the behavior record data are used to automatically adjust subsequent action plans by supplying historical summary information to the generative AI model as part of the first prompt sentence, thereby enabling personalized planning that accounts for previous deviations and emotion patterns.

In all embodiments, the server, the terminal, and the generative AI model operate together in a technical system that goes beyond simple automation of human planning or reporting. The system defines and uses specific machine data representations, non-conventional prompt-sentence constructions, domain-constrained neural network inference, and integrated spatial-emotional decision logic to achieve improved accuracy, speed, and resource usage in computer-implemented safety support and movement analysis.

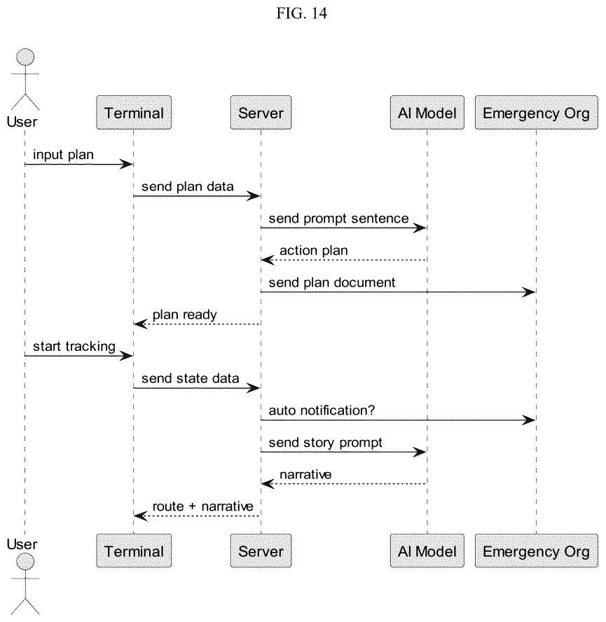

The following describes the processing flow using FIG. 14.

### Step 1:

User operates the terminal to input initial plan information.

User enters, via on-screen forms of the terminal application, parameters such as destination, date, difficulty level, activity type, and participant information.

Input: Raw keystrokes and UI events from the user.

Terminal converts these events into structured input fields (for example, strings for destination and date, categorical values for difficulty, numeric values for participant count).

Terminal performs client-side validation (for example, verifying that required fields are not empty and that the date is in the future) and stores the validated values in an internal data structure.

Output: Validated plan-input data structure inside the terminal (for example, a key-value map).

### Step 2:

Terminal transmits the plan-input data structure to the server.

Terminal packages the validated plan-input data into a serialized message and sends it to a predefined server endpoint using a secure communication protocol.

Input: In-memory plan-input data structure (destination, date, difficulty, activity type, participants).

Terminal converts the structure into a transport format, attaches a user identifier and authentication token, and transmits the message through the network interface.

Output: Network request containing structured plan-input data delivered to the server.

### Step 3:

Server receives and stores the plan-input data.

Server accepts the incoming request, authenticates the user, and parses the transported data into server-side objects.

Input: Serialized plan-input message received via the network interface.

Server deserializes the message, checks data types and value ranges, and inserts the plan-input fields into a persistent plan-input record within a database. This operation creates an internal identifier for later association with generated plans and logs.

Output: Stored plan-input record with a unique plan ID inside the server's database.

### Step 4:

Server generates a first prompt sentence for a generative AI model.

Server transforms the structured plan-input record into a natural-language instruction tailored for plan generation.

Input: Plan-input record (fields such as destination=“Mt. Fuji”, difficulty=“intermediate”, style=“day trip”, date=“future date”).

Server executes a template-filling algorithm: it selects a prompt template, inserts field values into predetermined positions, applies normalization (for example, converting codes into readable labels), and concatenates segments into a coherent sentence. For example, server generates: “The user wants to climb Mt. Fuji as an intermediate day trip. Generate a safe, detailed mountaineering plan including route, schedule, required equipment, and safety precautions.”

Output: First prompt sentence stored as text and linked to the plan ID.

### Step 5:

Server sends the first prompt sentence to the generative AI model and receives an action plan.

Server calls an external or internal generative AI model using the prepared prompt sentence.

Input: First prompt sentence and optional control parameters (for example, maximum length, temperature).

Server wraps the prompt sentence into a model request and transmits it through an application programming interface. The generative AI model tokenizes the sentence, runs it through a transformer network (embedding, attention, and feedforward layers), and generates tokens that form an action plan text. Server receives the generated text and checks for format consistency.

Output: Generated action plan text stored in an intermediate action-plan response object on the server.

### Step 6:

Server parses the generated action plan into a structured action-plan data structure.

Server converts the free-form text plan into discrete fields that can be processed algorithmically.

Input: Generated action plan text from the generative AI model.

Server applies text-segmentation rules, regular expressions, and keyword-based parsing to detect sections such as “Route,” “Schedule,” “Equipment,” and “Warnings.” Server extracts time expressions into time fields, location names into route elements, and bulleted lists into item arrays. The parsed fields are inserted into an action-plan data structure associated with the plan ID.

Output: Structured action-plan data stored in the server's database.

### Step 7:

Server generates plan document data based on the action-plan data structure.

Server formats the structured plan into a document suitable for emergency response organizations.

Input: Action-plan data structure and user metadata (for example, name and contact information).

Server invokes a document-layout module that maps fields to positions in a predefined template. The module populates headers, body sections, tables, and signatures, and then renders the content into a structured document format (for example, a page-oriented representation).

Output: Plan document data generated and stored in a document store with a reference to the plan ID.

### Step 8:

Server submits the plan document data to an emergency response organization.

Server transmits the formatted document through a defined communication channel.

Input: Plan document data and destination contact parameters (for example, address, endpoint URL).

Server either attaches the document to an electronic message or embeds it in a structured payload, sends it to the emergency organization, and awaits a delivery result. Server records the outcome (success or failure) in the database and updates a submission status field linked to the plan.

Output: Submission status record and stored association between the plan document and the emergency organization.

### Step 9:

Server notifies the terminal that the action plan and plan document are available.

Server informs the user that generation and submission have been completed.

Input: Internal event that indicates successful document generation and submission.

Server generates a notification payload containing plan status and summary information, then sends it to the terminal using a push-notification service or a polling response.

Output: Notification message delivered to the terminal.

### Step 10:

Terminal retrieves and displays the generated action plan.

Terminal requests detailed plan data from the server and renders it for the user.

Input: Notification message containing plan ID.

Terminal issues a data request to the server, receives the structured action-plan data and metadata, then populates user interface elements with route details, schedule items, and warnings. The terminal formats lists and time fields for readability, enabling the user to inspect and confirm the plan.

Output: Rendered plan information on the terminal display.

### Step 11:

User starts activity tracking and authorizes collection of position and emotion-related data.

User interacts with the terminal to start tracking for the planned activity.

Input: User command to start tracking and existing plan ID.

Terminal changes its internal tracking state from idle to active, initializes local buffers for position and emotion data, and displays confirmation to the user.

Output: Activated tracking session on the terminal associated with the plan ID.

### Step 12:

Terminal acquires and buffers position information data.

Terminal periodically uses its positioning module to obtain location samples.

Input: Internal timer events and sensor signals from positioning hardware.

Terminal queries the positioning module for latitude, longitude, altitude, and timestamp, then validates the readings (for example, discarding obviously invalid coordinates). Terminal appends each validated record to an in-memory buffer and, once a threshold is reached, persists the buffer to local storage and marks it ready for upload.

Output: Buffered and optionally stored local position-information batch.

### Step 13:

Terminal acquires and processes emotion-related data.

Terminal collects data that indicate the user's emotional state.

Input: Sensor frames from camera or microphone, or user-entered emotion labels.

Terminal either processes the sensor frames through a local emotion-recognition component to output emotion labels and intensities, or packages them for server-side analysis. The terminal tags each emotion record with a timestamp and, if available, a current position reference.

Output: Buffered emotion-related data records ready for transmission to the server.

### Step 14:

Terminal transmits state information batches to the server.

Terminal sends collected position and emotion-related data at defined intervals.

Input: Local buffers of position-information data and emotion-related data.

Terminal groups records into batches, compresses them if necessary, and transmits them to the server along with plan ID and user ID. Terminal marks each batch as sent to avoid duplicate uploads and logs any transmission failures for later retry.

Output: Network messages containing batched state information delivered to the server.

### Step 15:

Server stores and indexes time-ordered position information data.

Server receives and persists the state information for analysis.

Input: Batches of position-information data from the terminal.

Server deserializes the batch, validates timestamps and coordinates, and inserts each record into a time-series or spatial table keyed by user ID and plan ID. Server creates or updates time-based and spatial indexes, ensuring chronological order for later retrieval.

Output: Persisted and indexed position-information records inside the server database.

### Step 16:

Server stores and associates emotion-related data with corresponding time intervals.

Server processes emotion records and ties them to the time axis of the planned activity.

Input: Emotion-related data records from the terminal or from an external analysis service.

Server normalizes emotion labels, clamps intensity values to defined ranges, and inserts them into an emotion-log table. Server associates each emotion record with a user ID, plan ID, and timestamp, enabling precise alignment with position samples.

Output: Persisted emotion-log records with temporal linkage to position data.

### Step 17:

Server evaluates emergency-notification conditions based on plan and state information.

Server determines whether current conditions warrant an automatic alert.

Input: Latest position-information records, emotion-related records, and the stored action-plan data.

Server retrieves the expected route and schedule from the action-plan structure, compares current location and time to the expected segment, and computes deviation metrics (for example, time delay and distance from the planned path). Server also aggregates recent emotion intensities over a sliding time window. Based on predefined rules (for example, excessive delay combined with high fear intensity), server evaluates a decision function.

Output: Binary or graded decision result indicating whether to generate an emergency notification.

### Step 18:

Server generates and sends automatic notification data when conditions are satisfied.

Server composes an emergency message for response organizations.

Input: Positive decision result from emergency-condition evaluation and current state information.

Server extracts current position, user identifiers, and plan reference, constructs an automatic notification payload, and transmits it to a configured emergency response endpoint. Server records the time, content, and delivery result of the automatic notification in the database.

Output: Automatic notification delivered to an emergency response organization and corresponding log entry.

### Step 19:

Server reconstructs movement route information and computes stay time information.

Server converts raw position samples into a structured representation of the user's path.

Input: Time-ordered position-information records.

Server sorts positions by timestamp (if not already sorted), connects consecutive points into segments, and optionally applies smoothing or interpolation. Server detects clusters of points within spatial thresholds to identify regions where the user remained for extended periods.

For each region, server calculates stay duration by subtracting first and last timestamps.

Output: Movement route information and stay time information stored in a route-record structure.

### Step 20:

Server generates behavior record data by associating routes, emotions, and the action plan.

Server builds a unified record that can support analytical and narrative generation tasks.

Input: Movement route information, stay time information, emotion-log records, and action-plan data.

Server aligns emotion records with route segments by timestamp, annotates each segment with corresponding emotion labels and intensities, and attaches planned vs. actual timing comparisons. Server inserts this combined information into a behavior-record data structure keyed by plan ID.

Output: Behavior record data representing integrated spatial, temporal, emotional, and planning information.

### Step 21:

Server produces summary description information for narrative generation.

Server extracts key events and highlights from the behavior record.

Input: Behavior record data.

Server identifies significant events such as start, key checkpoints, summit, and completion based on changes in altitude and time gaps. Server also identifies periods with notable emotion intensity changes. The server compresses these events into a list of summary items, each containing time, location, and dominant emotion.

Output: Summary description information suitable for inclusion in a narrative prompt.

### Step 22:

Server generates a second prompt sentence for the generative AI model.

Server constructs a narrative-focused instruction that incorporates the summary description.

Input: Summary description information and contextual details from the action-plan data.

Server arranges the key events in temporal order and embeds them into a narrative-style instruction. For example, server generates: “The user climbed Mt. Fuji as an intermediate day trip. The route started at 06:00 from the fifth station, reached the summit at 11:00, and finished at 15:00. GPS data shows a steep and slow section between 08:00 and 09:00, where the user felt anxiety, and strong joy at the summit. Using this information, generate a narrative story of the hike that emphasizes the feeling of accomplishment at the summit.”

Output: Second prompt sentence stored as text associated with the behavior record.

### Step 23:

Server sends the second prompt sentence to the generative AI model and receives narrative content.

Server requests generation of a story aligned with the recorded behavior.

Input: Second prompt sentence and narrative-generation parameters (for example, target length, style).

Server transmits the prompt sentence via the model interface and receives generated narrative text. The text is checked for completeness and basic consistency (for example, presence of beginning and end segments).

Output: Narrative content text stored in association with the behavior record data.

### Step 24:

Server prepares record display data for the terminal.

Server aggregates all relevant elements into a compact representation for visualization.

Input: Movement route information, stay time information, narrative content, and summary statistics (for example, total distance and time).

Server formats route data into map-ready polyline coordinates, selects relevant statistics, and embeds the narrative content as structured text. Server packages these components into a record-display payload tuned for efficient transmission and rendering.

Output: Record display data ready for delivery to the terminal.

### Step 25:

Terminal requests and renders the record display data.

Terminal downloads and presents the completed activity record to the user.

Input: User selection of a completed plan record and plan ID.

Terminal sends a data request to the server, receives the record-display payload, and decodes route coordinates and narrative text. Terminal draws the route on a map component, overlays markers for key events, and displays the narrative text in a scrollable view, enabling the user to correlate visual path information with descriptive narrative.

Output: Visual and textual representation of the behavior record shown on the terminal screen.

### Step 26:

Terminal acquires identification information from wireless identification transmitters in an indoor environment.

Terminal supports indoor movement analysis when the user enters a facility equipped with transmitters.

Input: Wireless signals from identification transmitters and internal sampling schedule.

Terminal scans for signals, decodes identification values and signal strength, and timestamps each detection. Terminal stores the identification records in a local buffer for subsequent upload.

Output: Buffered identification-information records with timestamps.

### Step 27:

Server estimates an indoor movement path and computes movement-path analysis result data.

Server reconstructs the user's path through indoor zones based on identification information.

Input: Identification-information records, any available position-information data, and facility zone mappings.

Server maps each identification value to a specific zone in the facility, orders detections by time, and infers transitions between zones. Server computes dwell times and transition frequencies, then aggregates these metrics into movement-path analysis result data.

Output: Movement-path analysis result data describing indoor user behavior.

### Step 28:

Server outputs information for optimization of facility operation or service provision.

Server derives actionable insights from movement-path analysis.

Input: Movement-path analysis result data.

Server calculates zone-level metrics such as average dwell time and peak occupancy intervals, and generates optimization information (for example, recommendations or statistical summaries). Server provides this information via an administrative interface or an external reporting endpoint.

Output: Optimization information that can be consumed by facility-management systems or human operators.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

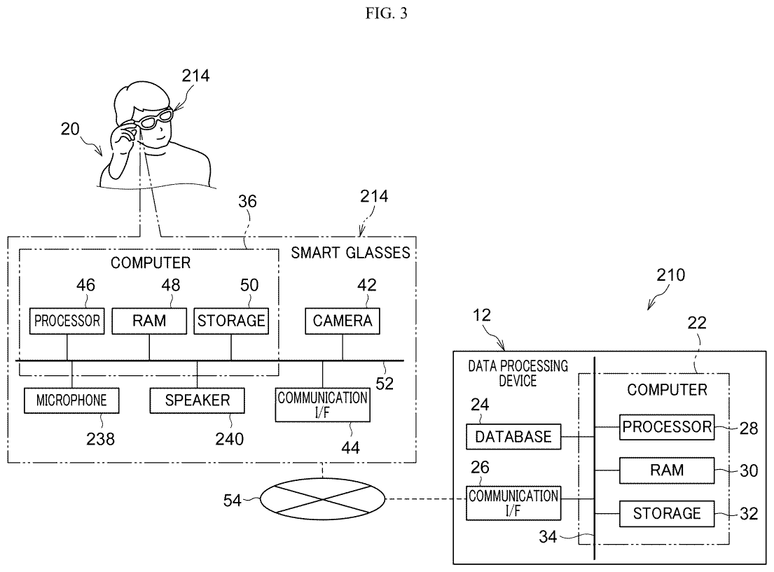

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

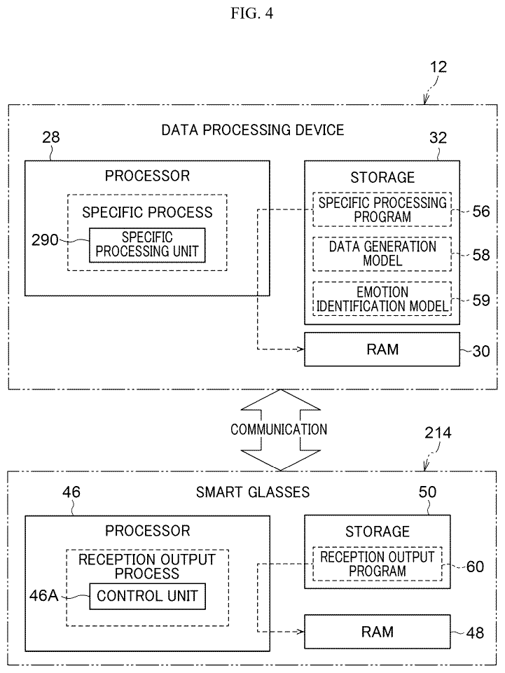

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

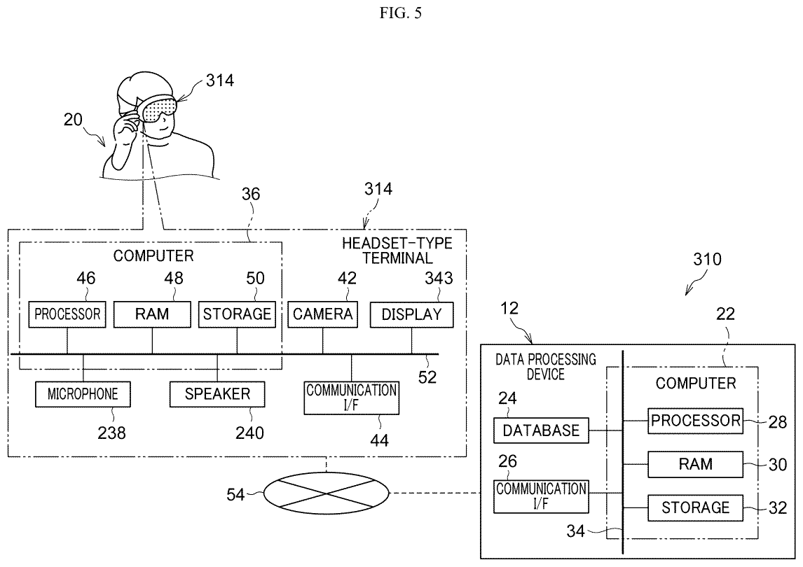

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

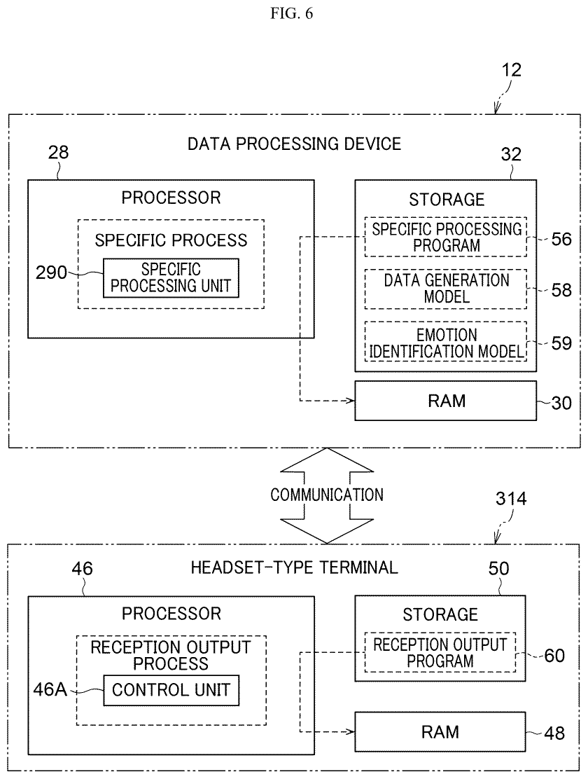

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

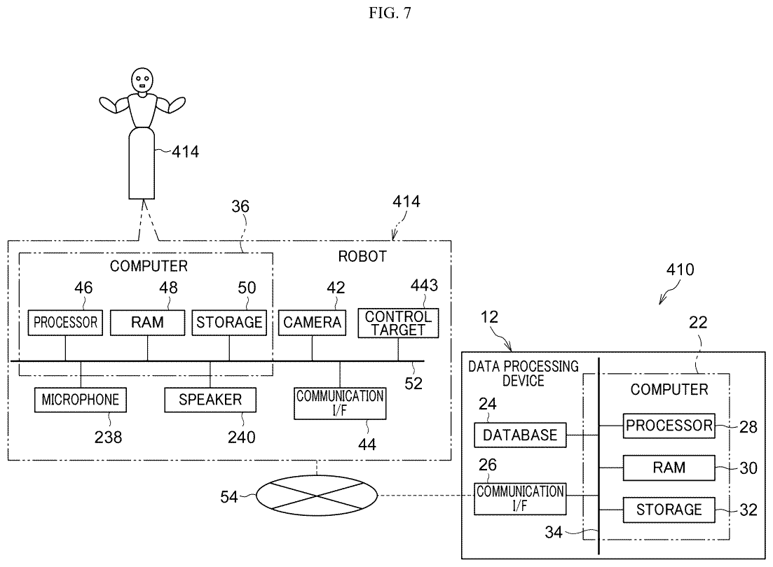

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

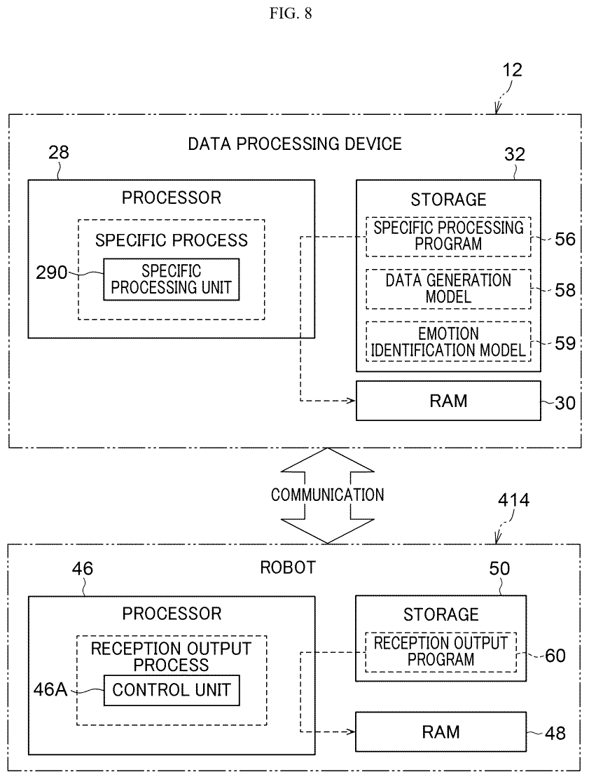

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

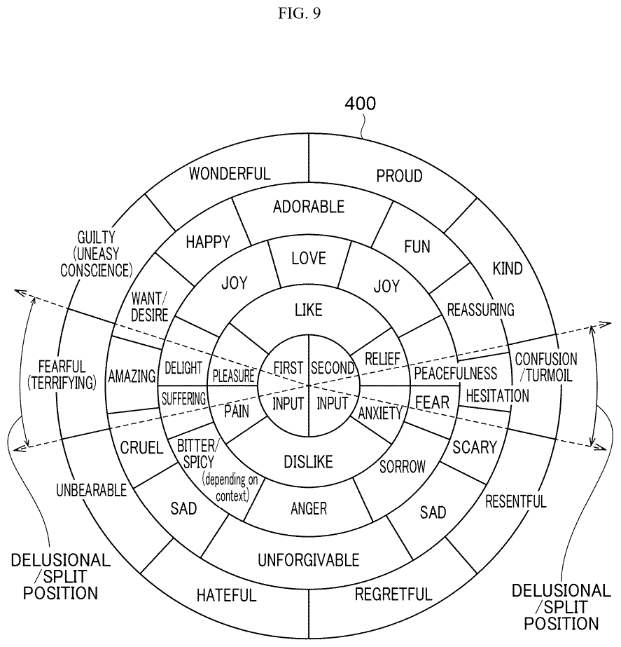

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

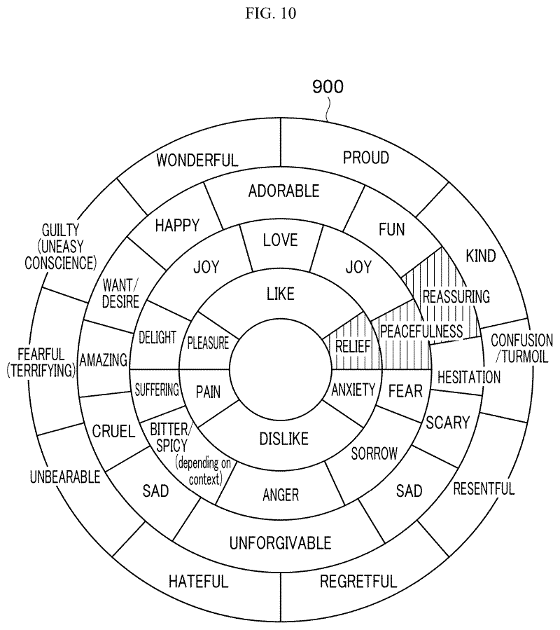

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire input information including destination information, user skill information, activity style information, and condition information from a user operation terminal, and generate base data by associating the input information with geographical information and route information stored in a storage unit,
convert the base data into character string data, and generate instruction sentence data as a prompt sentence for instructing creation of an activity plan, based on the input information, the geographical information, and the route information, transmit the instruction sentence data to a language processing function included in an external generative AI model, and obtain activity plan data including route information, time information, equipment information, and caution information by a text generation process performed by the generative AI model,
extract region identification information based on the activity plan data, acquire emergency contact information and facility information corresponding to the region identification information from the storage unit or from an external information providing apparatus, and add the emergency contact information and the facility information to the activity plan data, receive change instructions regarding the route information and the time information included in the activity plan data from the user operation terminal, regenerate the instruction sentence data based on the change instructions, and input the regenerated instruction sentence data to the generative AI model to obtain updated activity plan data,
generate plan document data in a predetermined format based on at least one of the activity plan data and the updated activity plan data and on the emergency contact information and the facility information, and format the plan document data as an electronic document by using a document generation function,
transmit the electronic document to a public organization or a rescue organization via a communication function, store a transmission result as management information, and notify the transmission result to the user operation terminal, and
store the activity plan data and the updated activity plan data in the storage unit in association with identification information, and provide the activity plan data to the user operation terminal in response to a request from the user operation terminal.

### (Supplementary 2)

The system according to supplementary 1,
wherein the processor is configured to
analyze text of the activity plan data obtained from the generative AI model, generate structured data classified into the route information, the time information, the equipment information, weather-related information, and emergency response information based on delimiter symbols or expression patterns, and output the structured data to the user operation terminal in a format allowing separate display of each classification.

### (Supplementary 3)

The system according to supplementary 1,
wherein the processor is configured to
accumulate position information acquired from the user operation terminal in time series, generate travel history data by comparing planned route information included in the activity plan data with the accumulated position information, and store the travel history data in the storage unit in association with the plan document data.

### Application Example 1

### (Supplementary 1)

A system comprising a processor,
wherein the processor is configured to
receive input information including preference conditions and constraint conditions of a user, and generate a prompt sentence for instructing a generative AI model to generate a service provision plan based on the input information,
input the prompt sentence to the generative AI model, and identify selection conditions regarding candidate service providers and service items based on an analysis result obtained from the generative AI model,
search service provider information and service item information stored in a storage device based on the selection conditions, and generate the service provision plan that satisfies the preference conditions and the constraint conditions of the user by executing evaluation processing on a search result,
output the generated service provision plan to a display device for the user, receive input for condition change or plan modification from the user, and regenerate the prompt sentence and the service provision plan in accordance with the condition change or the plan modification, and
acquire selection content based on the service provision plan from the user, generate order information corresponding to the selection content, and transmit the order information to an external provision service.

### (Supplementary 2)

The system according to supplementary 1,
wherein the processor is configured to
convert the analysis result obtained from the generative AI model into structured information, and dynamically set a search condition and an evaluation index for the service provider information and the service item information using the structured information to control generation processing of the service provision plan.

### (Supplementary 3)

The system according to supplementary 1,
wherein the processor is configured to
normalize the input information again when the input for the condition change or the plan modification from the user is received, and update the service provision plan iteratively by re-inputting a new prompt sentence reflecting a result of the normalization to the generative AI model.

### Example 2

### (Supplementary 1)

A system comprising a processor,
wherein the processor is configured to
receive abstract input information related to an activity plan from an operation apparatus used by a user, and generate a prompt sentence including the abstract input information to instruct a generative AI model to generate a detailed proposal of the activity plan,
input the prompt sentence into the generative AI model, analyze a detailed proposal of the activity plan output from the generative AI model, and convert the detailed proposal into plan information conforming to a predetermined format,
automatically generate document data corresponding to a format of a destination organization based on the plan information, and transmit the document data to the destination organization via a communication network,
receive position information including a current position from a portable information terminal having a position acquisition function, search an information storage unit storing geographic information and facility information, extract information related to emergency contacts and evacuation facilities in a vicinity of the current position, and transmit the extracted information to the portable information terminal,
when position information including an emergency flag is received from the portable information terminal, identify candidate evacuation facilities based on the position information, and cause at least information related to a nearest evacuation facility to be presented on the portable information terminal, and
record, in time series, position information transmitted at predetermined time intervals from the portable information terminal, reconstruct an activity trajectory based on the recorded position information, generate activity record data including the activity trajectory and at least a movement distance and a movement time, and provide the activity record data to the portable information terminal.

### (Supplementary 2)

The system according to supplementary 1,
wherein the processor is configured to
dynamically change contents of the prompt sentence to be input to the generative AI model based on at least one of the abstract input information related to the activity plan and the detailed proposal of the activity plan output from the generative AI model, so that plan information corresponding to a format of the destination organization and to a target activity domain is obtained.

### (Supplementary 3)

The system according to supplementary 1,
wherein the processor is configured to
store, in association with the activity record data, at least a part of the emergency contacts, the evacuation facilities, and the destination organization searched based on the position information in the information storage unit, and, in response to a request to view the activity record data, cause the portable information terminal to present, together with a past activity trajectory, contact information and facility information related to the past activity.

### Application Example 2

### (Supplementary 1)

A system comprising a processor,
wherein the processor is configured to
acquire input information from a user and generate a prompt sentence including the input information so as to instruct a generative AI model to generate an action plan, receive the action plan output from the generative AI model, automatically generate plan document data in a predetermined format based on the action plan, and electronically transmit the plan document data to an emergency response organization,
periodically acquire state information including position information data and emotion-related data from an information processing terminal of the user, determine necessity of an emergency notification based on the action plan and the state information, and, when the emotion-related data satisfies a predetermined condition, generate and transmit automatic notification data to the emergency response organization,
store the position information data in time order, generate movement route information and stay time information based on a storage result, and generate behavior record data in which the movement route information, the emotion-related data, and the action plan are associated with one another,
generate a story-generation prompt sentence including summary description information of the behavior record data and the emotion-related data, input the story-generation prompt sentence to the generative AI model to cause the generative AI model to generate content in a narrative format, and store the content in the narrative format in association with the behavior record data, and
provide record display data including the movement route information and the content in the narrative format to the information processing terminal of the user.

### (Supplementary 2)

The system according to supplementary 1,
wherein the processor is configured to, based on the position information data, acquire contact information and position information of emergency response bases from a plurality of base-information storage units in a predetermined area, provide the contact information and the position information to the information processing terminal of the user, and generate control information that enables the information processing terminal of the user to execute a notification operation by a single user operation.

### (Supplementary 3)

The system according to supplementary 1,
wherein the processor is configured to estimate a movement path of the user based on identification information acquired from a wireless identification transmitter installed in an indoor space and the position information data, analyze stay time in each area to generate movement-path analysis result data, and output information for optimization of facility operation or service provision using the movement-path analysis result data.

What is claimed is:

1. A system comprising:
circuitry configured to:
receive, via a communication interface coupled to a packet-switched network, input data comprising destination data, skill data, activity style data, and condition data from a terminal device, and generate base data by associating the input data with geographical data and route data stored in a storage device;
generate instruction sentence data as a prompt sentence for instructing a generative neural network model to generate activity plan data, based on the input data, the geographical data, and the route data, and transmit the instruction sentence data to the generative neural network model via the communication interface to obtain the activity plan data comprising route information, time information, equipment information, and caution information;
extract region identification information based on the activity plan data, acquire contact information and facility information corresponding to the region identification information from the storage device or from an external information providing apparatus via the communication interface, and add the contact information and the facility information to the activity plan data;
receive change instructions regarding the route information and the time information from the terminal device via the communication interface, regenerate the instruction sentence data based on the change instructions, and input the regenerated instruction sentence data to the generative neural network model to obtain updated activity plan data;
generate plan document data in a predetermined format based on at least one of the activity plan data and the updated activity plan data and on the contact information and the facility information, and transmit the plan document data as an electronic document to a destination organization via the communication interface; and
store the activity plan data and the updated activity plan data in the storage device in association with identification information, and provide the activity plan data to the terminal device in response to a request received via the communication interface.

2. The system according to claim 1, wherein the circuitry is configured to analyze text of the activity plan data obtained from the generative neural network model, generate structured data classified into the route information, the time information, the equipment information, weather-related information, and response information based on delimiter symbols or expression patterns, and output the structured data to the terminal device in a format allowing separate display of each classification.

3. The system according to claim 2, wherein the circuitry is configured to apply a classification model to the structured data to assign confidence scores to each classification, and to flag classifications with scores below a threshold for user verification prior to outputting the structured data to the terminal device.

4. The system according to claim 2, wherein the circuitry is configured to store the structured data in the storage device as versioned records, associating each version with a corresponding instruction sentence data input and a timestamp, and to provide a version comparison output to the terminal device upon request.

5. The system according to claim 1, wherein the circuitry is configured to accumulate position information acquired from the terminal device in time series, generate travel history data by comparing planned route information included in the activity plan data with the accumulated position information, and store the travel history data in the storage device in association with the plan document data.

6. The system according to claim 5, wherein the circuitry is configured to compute a deviation metric between the accumulated position information and the planned route information, and to transmit an alert notification to the terminal device via the communication interface when the deviation metric exceeds a threshold value.

7. The system according to claim 5, wherein the circuitry is configured to generate activity record data comprising a reconstructed activity trajectory, a movement distance, and a movement time based on the travel history data, and to provide the activity record data to the terminal device in response to a completion event signal received from the terminal device.

8. The system according to claim 1, wherein the circuitry is configured to receive, via the communication interface, position information including an emergency flag from the terminal device, identify candidate facilities based on the position information, and transmit information related to a nearest candidate facility to the terminal device via the communication interface.

9. The system according to claim 8, wherein the circuitry is configured to rank the candidate facilities by a proximity score computed from the position information and stored facility coordinate data, and to transmit a ranked list comprising at least three candidate facilities to the terminal device.

10. The system according to claim 8, wherein the circuitry is configured to log the emergency flag event, the position information, and the transmission result in the storage device as management data, and to update the management data upon receiving a status response from the terminal device via the communication interface.

11. The system according to claim 1, wherein the circuitry is configured to store a transmission result of the electronic document transmitted to the destination organization as management information in the storage device, and to notify the transmission result to the terminal device via the communication interface.

12. The system according to claim 11, wherein the circuitry is configured to perform a retry operation when the transmission result indicates a transmission failure, and to update the management information with a retry count and a final transmission status after each retry attempt.

13. The system according to claim 1, wherein the circuitry is configured to convert the base data into character string data prior to generating the instruction sentence data, and to dynamically update the prompt sentence by incorporating updated geographical data retrieved from the external information providing apparatus when the change instructions are received.

14. The system according to claim 1, wherein the circuitry is configured to normalize the input data by applying at least one of format standardization, unit conversion, or missing-value substitution prior to generating the base data.

15. The system according to claim 14, wherein the circuitry is configured to apply a validation function to the normalized input data to detect out-of-range values for the skill data and the condition data, and to transmit a correction request to the terminal device via the communication interface when an out-of-range value is detected.

16. The system according to claim 1, wherein the circuitry is configured to apply a plan evaluation function to the activity plan data to compute a feasibility score based on the route information, the time information, and the condition data, and to include the feasibility score in the activity plan data provided to the terminal device.

17. The system according to claim 16, wherein the circuitry is configured to generate a plurality of candidate activity plan data sets by applying different parameter configurations to the generative neural network model, compute a feasibility score for each candidate, and select the candidate with the highest feasibility score as the activity plan data.

18. A system comprising:
circuitry configured to:
receive, via a communication interface coupled to a packet-switched network, input data comprising destination data, skill data, activity style data, and condition data from a terminal device, and associate the input data with geographical data and route data stored in a storage device to generate base data;
convert the base data into character string data, generate instruction sentence data as a prompt sentence based on the input data, the geographical data, and the route data, and transmit the instruction sentence data to a generative neural network model via the communication interface to obtain activity plan data comprising route information, time information, equipment information, and caution information;
extract region identification information from the activity plan data, query the storage device and an external information providing apparatus via the communication interface to acquire contact information and facility information corresponding to the region identification information, and add the contact information and the facility information to the activity plan data;
receive change instructions regarding the route information and the time information from the terminal device, regenerate the instruction sentence data based on the change instructions, input the regenerated instruction sentence data to the generative neural network model to obtain updated activity plan data, and store the activity plan data and the updated activity plan data in the storage device in association with identification information;
generate plan document data in a predetermined format based on at least one of the activity plan data and the updated activity plan data and on the contact information and the facility information, transmit the plan document data as an electronic document to a destination organization via the communication interface, and store a transmission result as management information in the storage device; and
accumulate position information received from the terminal device in time series, generate travel history data by comparing the route information included in the activity plan data with the accumulated position information, and store the travel history data in the storage device in association with the plan document data.

19. The system according to claim 18, wherein the circuitry is configured to compute a deviation metric between the accumulated position information and the route information, and to transmit an alert notification to the terminal device via the communication interface when the deviation metric exceeds a threshold value.

20. A method comprising:
receiving, via a communication interface coupled to a packet-switched network, input data comprising destination data, skill data, activity style data, and condition data from a terminal device, and generating base data by associating the input data with geographical data and route data stored in a storage device;
generating instruction sentence data as a prompt sentence for instructing a generative neural network model to generate activity plan data, based on the input data, the geographical data, and the route data, and transmitting the instruction sentence data to the generative neural network model via the communication interface to obtain the activity plan data comprising route information, time information, equipment information, and caution information;
extracting region identification information based on the activity plan data, acquiring contact information and facility information corresponding to the region identification information from at least one of the storage device or an external information providing apparatus, and adding the contact information and the facility information to the activity plan data;
receiving change instructions regarding the route information and the time information from the terminal device via the communication interface, regenerating the instruction sentence data based on the change instructions, and inputting the regenerated instruction sentence data to the generative neural network model to obtain updated activity plan data;
generating plan document data in a predetermined format based on at least one of the activity plan data and the updated activity plan data and on the contact information and the facility information, and transmitting the plan document data as an electronic document to a destination organization via the communication interface; and
storing the activity plan data and the updated activity plan data in the storage device in association with identification information, and providing the activity plan data to the terminal device in response to a request received via the communication interface.
